(19) United States
(12) Patent Application Publication
(10) Pub. No.: US 2026/0176445 A1
(43) Pub. Date: Jun. 25, 2026

(54) NON-FLUORINATED INVISIBLE FINGERPRINT COATINGS

(71) Applicant: Henkel AG & Co. KGaA, Duesseldorf (DE)

(72) Inventors: Bong Zhang, Chestnut Hill, MA (US); Miguel Galvez, Danvers, MA (US); Nikhil Puranik, Burlington, MA (US)

(21) Appl. No.: 19/534,105

(22) Filed: Feb. 9, 2026

Related U.S. Application Data
(63) Continuation of application No. PCT/US2024/041347, filed on Aug. 7, 2024.
(60) Provisional application No. 63/531,097, filed on Aug. 7, 2023.

(51) Int. Cl. C08K 5/00; C08F 220/24

(52) U.S. Cl. CPC C08K 5/0025; C08F 220/24

(57) ABSTRACT

Compositions (e.g., coatings) comprising an invisible fingerprint material, and related articles, methods, and kits, are generally described. In certain embodiments, the coating comprises an invisible fingerprint material that is configured to hide the appearance of fingerprints on a surface on which the coating is disposed. In some embodiments, for example, the invisible fingerprint material is configured to cause oils to spread along the surface on which the coating is disposed. The invisible fingerprint properties of the coating may be provided, in certain embodiments, by a reaction product of one or more silane-containing crosslinking agents and a silane-containing additive (e.g., a polydimethylsiloxane-containing additive, a polyethylene glycol-containing additive).

### TECHNICAL FIELD

Compositions (e.g., coatings) comprising an invisible fingerprint material, and related articles, methods, and kits, are generally described.

### BACKGROUND

Invisible fingerprint coatings cause oils to appear invisible, or nearly invisible, by causing the oils to spread along a surface on which the invisible fingerprint coating is disposed. Conventional invisible fingerprint materials used in coatings comprise fluorinated components that present toxicity and bioaccumulation issues that limit large-scale applications of the materials. Furthermore, conventional invisible fingerprint materials used in coatings have high coefficient of friction values, which reduces the abrasion resistance of the coating.

Accordingly, improved compositions, and related articles, methods, and kits, are necessary.

### SUMMARY

Compositions (e.g., coatings) comprising an invisible fingerprint material, and related articles, methods, and kits, are generally described. The subject matter of the present invention involves, in some cases, interrelated products, alternative solutions to a particular problem, and/or a plurality of different uses of one or more systems and/or articles.

According to certain embodiments, a composition is described. In some embodiments, the composition comprises an invisible fingerprint material comprising a reaction product of one or more silane-containing crosslinking agents and an additive comprising at least one hydrolysable moiety. In certain embodiments, the invisible fingerprint material comprises the additive in an amount greater than or equal to 0.1 weight percent (wt. %) and less than or equal to 5 wt. % versus a total weight of the invisible fingerprint material. In some embodiments, the invisible fingerprint material is non-fluorinated. According to certain embodiments, the composition has a coefficient of friction of greater than or equal to 0.01 and less than or equal to 0.1.

According to some embodiments, a composition comprises an invisible fingerprint material comprising a reaction product of one or more silane-containing crosslinking agents and an additive comprising at least one hydrolysable moiety. In certain embodiments, the invisible fingerprint material comprises the additive in an amount greater than or equal to 0.1 weight percent (wt. %) and less than or equal to 5 wt. % versus a total weight of the invisible fingerprint material. In some embodiments, the invisible fingerprint material is non-fluorinated. In certain embodiments, the additive comprises a linear or branched compound of the formula:

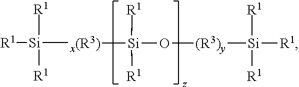

wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, OR², and —O—Si(R¹)₂—(R³)ₓ—[Si(R¹)₂—O]_{z}—(R³)_{y}—Si(R¹)₃,
each R² is the same or different and is selected from the group consisting of hydrogen, deuterium, —C₁-C₁₀ alkyl, —C₂-C₁₀ alkenyl, and —C₃-C₁₀ alkynyl,
each R³ is the same of different and is selected from the group consisting of oxygen, —C₁-C₁₀ alkylene-, —C₂-C₁₀ alkenylene-, and —C₃-C₁₀ alkynylene-,
each x is independently greater than or equal to 0,
each y is independently less than or equal to 5, and
each z is independently greater than or equal to 1.

According to certain embodiments, a composition comprises an invisible fingerprint material comprising a reaction product of one or more silane-containing crosslinking agents and an additive comprising at least one hydrolysable moiety. In certain embodiments, the invisible fingerprint material comprises the additive in an amount greater than or equal to 0.1 weight percent (wt. %) and less than or equal to 5 wt. % versus a total weight of the invisible fingerprint material. In some embodiments, the invisible fingerprint material is non-fluorinated. In certain embodiments, the additive comprises a linear or branched compound of the formula:

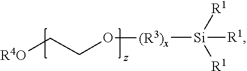

wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, OR², and —O—[(CH₂)₂—O]_{z}—(R³)ₓ—Si(R¹)₃,
each R² is the same or different and is selected from the group consisting of hydrogen, deuterium, —C₁-C₁₀ alkyl, —C₂-C₁₀ alkenyl, and —C₃-C₁₀ alkynyl,
each R³ is selected from the group consisting of oxygen, —C₁-C₁₀ alkylene-, —C₂-C₁₀ alkenylene-, and —C₃-C₁₀ alkynylene-,
R⁴ is selected from the group consisting of hydrogen, deuterium, —C₁-C₁₀ alkyl, —C₂-C₁₀ alkenyl, and —C₃-C₁₀ alkynyl,
each x is independently greater than or equal to 0, and
each z is independently greater than or equal to 1.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows, according to certain embodiments, a schematic diagram of an exemplary article.

FIG. 2 shows, according to certain embodiments, a schematic diagram of an exemplary method of coating a substrate.

FIG. 3 shows, according to certain embodiments, a schematic representation of the synthesis of an invisible fingerprint material comprising polydimethylsiloxane.

FIG. 4A shows, according to certain embodiments, the water contact angles and diiodomethane contact angles of the invisible fingerprint material synthesized as shown in FIG. 3 with various concentrations of additive before linear abrasion cycles.

FIG. 4B shows, according to certain embodiments, the water contact angles and diiodomethane contact angles of the invisible fingerprint material synthesized as shown in FIG. 3 with various concentrations of additive after 5,000 linear abrasion cycles.

FIG. 5 shows, according to certain embodiments, a schematic representation of the synthesis of another invisible fingerprint material comprising polydimethylsiloxane.

FIG. 6A shows, according to certain embodiments, the water contact angles and diiodomethane contact angles of the invisible fingerprint material synthesized as shown in FIG. 5 with various concentrations of additive before linear abrasion cycles.

FIG. 6B shows, according to certain embodiments, the water contact angles and diiodomethane contact angles the invisible fingerprint material synthesized as shown in FIG. 5 with various concentrations of additive after 5,000 linear abrasion cycles.

FIG. 7 shows, according to certain embodiments, a schematic representation of the synthesis of yet another invisible fingerprint material comprising polydimethylsiloxane.

FIG. 8A shows, according to certain embodiments, the water contact angles and diiodomethane contact angles of the invisible fingerprint material synthesized as shown in FIG. 7 with various concentrations of additive before linear abrasion cycles.

FIG. 8B shows, according to certain embodiments, the water contact angles and diiodomethane contact angles of the invisible fingerprint material synthesized as shown in FIG. 7 with various concentrations of additive after 5,000 linear abrasion cycles.

FIG. 9A shows, according to certain embodiments, the coefficient of friction of an invisible fingerprint material comprising a polydimethylsiloxane additive.

FIG. 9B shows, according to certain embodiments, the coefficient of friction of an invisible fingerprint material that does not include an additive.

FIG. 10 shows, according to certain embodiments, a schematic representation of the synthesis of an invisible fingerprint material comprising polyethylene glycol.

FIG. 11A shows, according to certain embodiments, the water contact angles and diiodomethane contact angles of the invisible fingerprint material synthesized as shown in FIG. 10 with various concentrations of additive before linear abrasion cycles.

FIG. 11B shows, according to certain embodiments, the water contact angles and diiodomethane contact angles of the invisible fingerprint material synthesized as shown in FIG. 10 with various concentrations of additive after 5,000 linear abrasion cycles.

### DETAILED DESCRIPTION

Compositions (e.g., coatings) comprising an invisible fingerprint material, and related articles, methods, and kits, are generally described. In certain embodiments, the coating comprises an invisible fingerprint material that is configured to hide the appearance of fingerprints on a surface on which the coating is disposed. In some embodiments, for example, the invisible fingerprint material is configured to cause oils to spread along the surface on which the coating is disposed. The invisible fingerprint properties of the coating may be provided, in certain embodiments, by a reaction product of one or more silane-containing crosslinking agents and a silane-containing additive (e.g., a polydimethylsiloxane-containing additive, a polyethylene glycol-containing additive). The reaction product of the invisible fingerprint material may advantageously render the coating both hydrophobic and oleophilic at the same time. In addition to providing invisible fingerprint properties, the coating may be chemically inert, mechanically robust, optically transparent, and/or lubricious, in accordance with certain embodiments.

Advantageously, the compositions (e.g., coatings), articles, methods, and kits described herein may have beneficial properties as compared to conventional coatings and related methods. In some embodiments, for example, the coating is non-fluorinated, thereby obviating issues related to toxicity and/or bioaccumulation that accompany conventional coatings comprising invisible materials that include fluorinated components. Furthermore, conventional coatings comprising fluorinated components also utilize fluorinated solvents for synthesis and/or processing. The non-fluorinated coatings described herein advantageously avoid the use of such fluorinated solvents, therefore decreasing fluorinated greenhouse gas emissions.

According to certain embodiments, the additive may advantageously provide a lubricious invisible fingerprint material with a lower coefficient of friction as compared to an invisible fingerprint material that does not include the additive but is otherwise equivalent. The coefficient of friction of the invisible fingerprint material may be inversely proportional to the amount of additive included in the invisible fingerprint material, in certain aspects. In some embodiments, however, the oleophobicity of the invisible fingerprint material may be proportional to the amount of additive included in the invisible fingerprint material. The amount of the additive may therefore be tuned depending on the particular application. In some embodiments, for example, if a lower coefficient of friction is desired, the invisible fingerprint material may include more of the additive, but if a higher oleophilicity is desired, the invisible fingerprint material may include less of the additive. In certain embodiments, the invisible fingerprint material comprises the additive in an amount of 0.1 weight (wt. %) to 5 wt. % versus the total weight of the invisible fingerprint material, which provides a desired coefficient of friction and oleophilicty.

The composition comprising the invisible fingerprint material may be used for any of a variety of suitable applications. In certain embodiments, for example, the composition may be applied (e.g., as a coating) on a substrate such as a glass, plastic, metal, and/or metal oxide, for example, as used in electronic displays such as, but not limited to, cell phone screens, computer monitors, television screens, touch screens, appliances, and/or heads up displays. In some embodiments, the composition may be applied (e.g., as a coating) on a substrate for use in transportation vehicles (e.g., cars, aircrafts, and the like) and/or building equipment.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

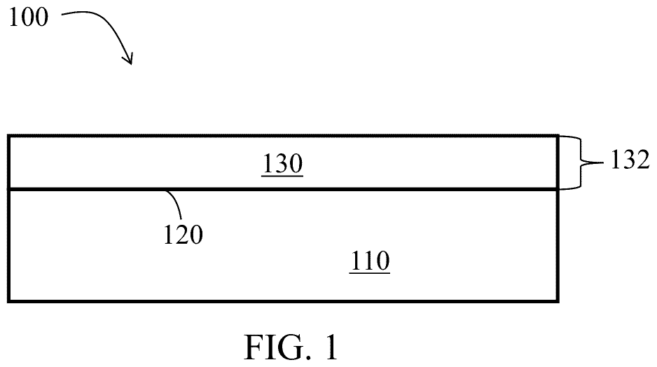

FIG. 1 shows, according to certain embodiments, a schematic diagram of an exemplary article. In certain embodiments, article 100 comprises substrate 110 comprising at least one surface 120. Suitable substrate materials are explained in further detail herein.

In accordance with certain embodiments, composition 130 may be disposed on at least a portion of at least one surface 120 of substrate 110 such that composition 130 coats at least the portion of at least one surface 120 of substrate 110. In some embodiments, composition 130 comprises an invisible fingerprint material, which is explained in further detail herein.

In certain embodiments, the composition coating the surface of the substrate may have any of a variety of suitable thicknesses. Referring to FIG. 1, for example, composition 130 coating at least the portion of at least one surface 120 of substrate 110 may have thickness 132.

In some embodiments, the composition coating the surface has an average thickness of greater than or equal to 5 nm, greater than or equal to 10 nm, greater than or equal to 20 nm, greater than or equal to 30 nm, greater than or equal to 40 nm, greater than or equal to 50 nm, greater than or equal to 60 nm, greater than or equal to 70 nm, greater than or equal to 80 nm, or greater than or equal to 90 nm. In certain embodiments, the composition coating the surface has an average thickness of less than or equal to 100 nm, less than or equal to 90 nm, less than or equal to 80 nm, less than or equal to 70 nm, less than or equal to 60 nm, less than or equal to 50 nm, less than or equal to 40 nm, less than or equal to 30 nm, less than or equal to 20 nm, or less than or equal to 10 nm. Combinations of the above recited ranges are possible (e.g., the composition coating the surface has an average thickness of greater than or equal to 5 nm and less than or equal to 100 nm, the composition coating the surface has an average thickness of greater than or equal to 40 nm and less than or equal to 60 nm). Other ranges are also possible. In certain embodiments, the average thickness of the composition coating the surface may be determined by ellipsometry.

While composition 130 coating surface 120 of substrate 110 is depicted in FIG. 1 as a smooth layer of uniform thickness, those of ordinary skill in the art would understand that this is for illustration purposes only and the thickness of the composition coating the surface of the substrate may have a particular roughness and/or may vary in thickness, in accordance with some embodiments. In certain embodiments, the composition coating the surface of the substrate may be of relatively uniform thickness (e.g., within less than or equal to 10% of the total thickness) over at least a substantial portion of the surface of the substrate (e.g., greater than or equal to 75% of the surface area of the surface of the substrate on which the composition is disposed).

In some embodiments, the composition comprises an invisible fingerprint material. The invisible fingerprint material is non-fluorinated, in accordance with certain embodiments, such that the invisible fingerprint material does not comprise any fluorine (F) atoms.

The composition may comprise the invisible fingerprint material in any of a variety of suitable amounts. In certain embodiments, for example, the composition comprises the invisible fingerprint material in an amount greater than or equal to 0.1 weight percent (wt. %), greater than or equal to 1 wt. %, greater than or equal to 5 wt. %, greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % based on the total weight of the composition. In some embodiments, the composition comprises the invisible fingerprint material in an amount less than or equal to 100 wt. %, less than or equal to 99 wt. %, less than or equal to 95 wt. %, less than or equal to 90 wt. %, less than or equal to 80 wt. %, less than or equal to 70 wt. %, less than or equal to 60 wt. %, less than or equal to 50 wt. %, less than or equal to 40 wt. %, less than or equal to 30 wt. %, less than or equal to 20 wt. %, less than or equal to 10 wt. %, less than or equal to 5 wt. %, or less than or equal to 1 wt. % based on the total weight of the composition. Combinations of the above recited ranges are possible (e.g., the composition comprises the invisible fingerprint material in an amount greater than or equal to 0.1 wt. % and less than or equal to 100 wt. % based on the total weight of the composition, the composition comprises the invisible fingerprint material in an amount greater than or equal to 40 wt. % and less than or equal to 60 wt. % based on the total weight of the composition). Other ranges are also possible.

In certain embodiments, the amount of the invisible fingerprint material in the composition may depend on the technique used to the dispose the composition on the surface of the substrate. For example, in some embodiments wherein the composition is sprayed on the surface of the substrate, the composition may comprise the invisible fingerprint material in an amount greater than or equal to 0.1 wt. % and less than or equal to 10 wt. % versus the total weight of the composition. In other embodiments in which the composition is deposited on the surface of the substrate (e.g., via chemical vapor deposition and/or physical vapor deposition), the composition may comprise the invisible fingerprint material in an amount greater than or equal to 50 wt. % and less than or equal to 100 wt. %. Other methods of disposing the composition on a surface of a substrate are explained herein in greater detail.

According to certain embodiments, the invisible fingerprint material comprises a reaction product of one or more silane-containing crosslinking agents and an additive comprising a hydrolysable moiety. Suitable reaction products, silane-containing crosslinking agents, and additives are explained herein in greater detail.

As described herein, the invisible fingerprint material comprises one or more silane-containing crosslinking agents, in accordance with certain embodiments. According to certain embodiments, the one or more silane-containing crosslinking agents comprise at least one hydrolysable moiety. The one or more silane-containing crosslinking agents may comprise any of a variety of suitable hydrolysable moieties. In certain embodiments, for example, the hydrolysable moiety of the one or more silane-containing crosslinking agents comprises an alkoxy moiety (e.g., an —OR moiety), a hydroxyl (—OH) moiety, a hydrogen moiety (—H), a halogen moiety, provided that the halogen moiety is not fluorine (e.g., a —Cl moiety, a —Br moiety, and —I moiety), an amine, other leaving groups, and/or combinations thereof. In some non-limiting embodiments, a hydrogen moiety directly attached (e.g., bound) to silicon (e.g., —Si—H) is a hydrolysable moiety. Other hydrolysable moieties are also possible.

In some embodiments, at least one silane-containing crosslinking agent comprises an alkyl chain. The alkyl chain may comprise any of a variety of suitable alkyl groups (e.g., —CₙH₂ₙ₊₁ groups, wherein n is greater than or equal to 2). In certain embodiments, for example, the alkyl chain comprises greater than or equal to 2, greater than or equal to 4, greater than or equal to 6, greater than or equal to 8, greater than or equal to 10, greater than or equal to 12, greater than or equal to 14, greater than or equal to 16, or greater than or equal to 18 alkyl groups. In some embodiments, the alkyl chain comprises less than or equal to 20, less than or equal to 18, less than or equal to 16, less than or equal to 14, less than or equal to 12, less than or equal to 10, less than or equal to 8, less than or equal to 6, or less than or equal to 4 alkyl groups. Combinations of the above recited ranges are possible (e.g., the alkyl chain comprises greater or equal to 2 and less than or equal to 20 alkyl groups, the alkyl chain comprises greater than or equal to 8 and less than or equal to 12 alkyl groups). Other ranges are also possible.

According to some embodiments, at least one silane-containing crosslinking agent comprises an oleophilic moiety. As used herein, the term “oleophilic moiety” is given its ordinary meaning in the art and refers to a moiety having a strong affinity for oils rather than water.

Any of a variety of suitable oleophilic moieties are possible. In certain embodiments, the oleophilic moiety comprises chlorine (Cl). Other oleophobic moieties are also possible.

In some embodiments, at least one silane-containing crosslinking agent comprises a compound of Formula (I):

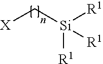

wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, and OR²;
each R² is the same or different and is selected from the group consisting of hydrogen, deuterium, —C₁-C₁₀ alkyl, —C₂-C₁₀ alkenyl, and —C₃-C₁₀ alkynyl;
X is a halogen, provided that the halogen is not a fluorine moiety; and
n is greater than or equal to 1 and less than or equal to 20.

The value of “n” in the compound of Formula (I) may be any of a variety of suitable values. In certain embodiments, for example, the value of “n” is greater than or equal to 1, greater than or equal to 5, greater than or equal to 10, or greater than or equal to 15. In some embodiments, the value of “n” is less than or equal to 20, less than or equal to 15, less than or equal to 10, or less than or equal to 5. Combinations of the above referenced ranges are possible (e.g., the value of “n” is greater than or equal to 1 and less than or equal to 20, the value of “n” is greater than or equal to 5 and less than or equal to 15). Other ranges are also possible.

According to certain embodiments, “X” in the compound of Formula (I) is chlorine (Cl), bromine (Br), or iodine (I).

According to some embodiments, at least one silane-containing crosslinking agent comprises a compound of Formula (II):

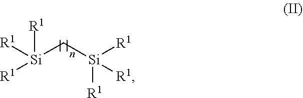

wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, and OR²;
each R² is the same or different and is selected from the group consisting of hydrogen, deuterium, —C₁-C₁₀ alkyl, —C₂-C₁₀ alkenyl, and —C₃-C₁₀ alkynyl; and
n is greater than or equal to 1 and less than or equal to 20.

The value of “n” in the compound of Formula (II) may be any of a variety of suitable values. In certain embodiments, for example, the value of “n” is greater than or equal to 1, greater than or equal to 2, greater than or equal to 5, greater than or equal to 10, or greater than or equal to 15. In some embodiments, the value of “n” is less than or equal to 20, less than or equal to 15, less than or equal to 10, less than or equal to 5, or less than or equal to 2. Combinations of the above referenced ranges are possible (e.g., the value of “n” is greater than or equal to 1 and less than or equal to 20, the value of “n” is greater than or equal to 2 and less than or equal to 5). Other ranges are also possible.

According to certain embodiments, at least one silane-containing crosslinking agent comprises a compound of Formula (III):

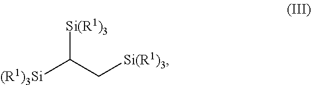

wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, and OR²; and each R² is the same or different and is selected from the group consisting of hydrogen, deuterium, —C₁-C₁₀ alkyl, —C₂-C₁₀ alkenyl, and —C₃-C₁₀ alkynyl.

In certain embodiments, at least one silane-containing crosslinking agent comprises a chloro-substituted alkoxysilane; (chloromethyl)trimethoxysilane; (2-chloroethyl)trimethoxysilane; (3-chloropropyl)trimethoxysilane; (4-chlorobutyl)trimethoxysilane; (5-chloropentyl)trimethoxysilane; (6-chlorohexyl)trimethoxysilane; (7-chloroheptyl)trimethoxysilane; (8-chlorooctyl)trimethoxysilane; (9-chlorononyl)trimethoxysilane; (10-chlorodecyl)trimethoxysilane; (11-undecyl)trimethoxysilane); (12-chlorododecyl)trimethoxysilane); (13-chlorotridecyl)trimethoxysilane); (14-tetradecyl)trimethoxysilane); (chloromethyl)triethoxysilane; (2-chloroethyl)triethoxysilane; (3-chloropropyl)triethoxysilane; (4-chlorobutyl)triethoxysilane; (5-chloropentyl)triethoxysilane; (6-chlorohexyl)triethoxysilane; (7-chloroheptyl)triethoxysilane; (8-chlorooctyl)triethoxysilane; (9-chlorononyl)triethoxysilane; (10-chlorodecyl)triethoxysilane; (11-chloroundecyl)triethoxysilane); (12-chlorododecyl)triethoxysilane); (13-chlorotridecyl)triethoxysilane); (14-tetradecyl)triethoxysilane); a 1,2-bis(alkoxysilyl)ethane; 1,2-bis(trimethoxysilyl)ethane; 1,2-bis(triethoxysilyl)ethane; a 1,1,2-tris(alkoxysilyl)ethane); 1,1,2-tris(trimethoxysilyl)ethane; and/or 1,1,2-tris(triethoxysilyl)ethane. Other silane-containing crosslinking agents are also possible.

The invisible fingerprint material may comprise the one or more silane-containing crosslinking agents in any of a variety of suitable amounts. In some embodiments, for example, the invisible fingerprint material comprises the one or more silane-containing crosslinking agents in an amount greater than or equal to 5 wt. %, greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, greater than or equal to 90 wt. %, or greater than or equal to 95 wt. % versus the total weight of the invisible fingerprint material. In certain embodiments, the invisible fingerprint material comprises the one or more silane-containing crosslinking agents in an amount less than or equal to 99 wt. %, less than or equal to 95 wt. %, less than or equal to 90 wt. %, less than or equal to 80 wt. %, less than or equal to 70 wt. %, less than or equal to 60 wt. %, less than or equal to 50 wt. %, less than or equal to 40 wt. %, less than or equal to 30 wt. %, less than or equal to 20 wt. %, or less than or equal to 10 wt. % versus the total weight of the invisible fingerprint material. Combinations of the above recited ranges are possible (e.g., the invisible fingerprint material comprises the one or more silane-containing crosslinking agents in an amount greater than or equal to 5 wt. % and less than or equal to 99 wt. % versus the total weight of the invisible fingerprint material, the invisible fingerprint material comprises the one or more silane-containing crosslinking agents in an amount greater than or equal to 40 wt. % and less than or equal to 60 wt. % versus the total weight of the invisible fingerprint material). Other ranges are also possible.

As described above, the invisible fingerprint material comprises an additive, in accordance with certain embodiments. According to some embodiments, incorporating the additive into the invisible fingerprint material may advantageously lower the coefficient of friction of the invisible fingerprint material, as explained herein in greater detail.

According to some embodiments, the additive may comprise at least one hydrolysable moiety. The additive may comprise any of a variety of suitable hydrolysable moieties. In some embodiments, for example, the additive comprises an alkoxy moiety (e.g., an —OR moiety), a hydroxyl (—OH) moiety, a hydrogen (—H) moiety, a halogen moiety, provided that the halogen is not a fluorine moiety, (e.g., a —Cl moiety, a —Br moiety, and —I moiety), an amine, other leaving groups, and/or combinations thereof. In certain non-limiting embodiments, a hydrogen moiety directly attached (e.g., bound) to a silicon (e.g., —Si—H) is a hydrolysable moiety. Other hydrolysable moieties are also possible.

\According to certain embodiments, the additive comprises a linear compound. In other embodiments, the additive comprises a branched compound.

In some embodiments, the additive comprises a linear or branched compound of Formula (IV):

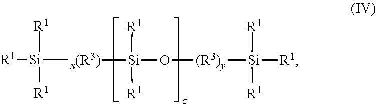

wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, OR², and —O—Si(R¹)₂—(R³)ₓ—[Si(R¹)₂—O]_{z}—(R³)_{y}—Si(R¹)₃;
each R² is the same or different and is selected from the group consisting of hydrogen, deuterium, —C₁-C₁₀ alkyl, —C₂-C₁₀ alkenyl, and —C₃-C₁₀ alkynyl;
each R³ is the same of different and is selected from the group consisting of oxygen, —C₁-C₁₀ alkylene-, —C₂-C₁₀ alkenylene-, and —C₃-C₁₀ alkynylene-;
each x is independently greater than or equal to 0;
each y is independently less than or equal to 5; and
each z is independently greater than or equal to 1.

The value of each “x” in the compound of Formula (IV) may be any of a variety of suitable values. In certain embodiments, for example, each “x” is greater than or equal to 0, greater than or equal to 1, greater than or equal to 2, greater than or equal to 5, greater than or equal to 10, greater than or equal to 20, or greater than or equal to 50. In some embodiments, each “x” is less than or equal to 100, less than or equal to 50, less than or equal to 20, less than or equal to 10, less than or equal to 5, or less than or equal to 1. Combinations of the above recited ranges are possible (e.g., each “x” is greater than or equal to 0 and less than or equal to 100, each “x” is greater than or equal to 5 and less than or equal to 10). Other ranges are also possible.

The value of each “y” in the compound of Formula (IV) may be any of a variety of suitable values. In certain embodiments, for example, each “y” is less than or equal to 5, less than or equal to 4, less than or equal to 3, less than or equal to 2, or less than or equal to 1. In some embodiments, each “y” is greater than or equal to 0, greater than or equal to 1, greater than or equal to 2, greater than or equal to 3, or greater than or equal to 4. Combinations of the above recited ranges are possible (e.g., each “y” is less than or equal to 5 and greater than or equal to 0, each “y” is less than or equal to 3 and greater than or equal to 2). Other ranges are also possible.

The value of each “z” in the compound of Formula (IV) may be any of a variety of suitable values. In certain embodiments, for example, each “z” is greater than or equal to 1, greater than or equal to 2, greater than or equal to 10, greater than or equal to 50, greater than or equal to 100, greater than or equal to 200, greater than or equal to 300, greater than or equal to 400, greater than or equal to 500, greater than or equal to 600, greater than or equal to 700, greater than or equal to 800, or greater than or equal to 900. In some embodiments, each “z” is less than or equal to 1,000, less than or equal to 900, less than or equal to 800, less than or equal to 700, less than or equal to 600, less than or equal to 500, less than or equal to 400, less than or equal to 300, less than or equal to 200, less than or equal to 100, less than or equal to 50, less than or equal to 10, or less than or equal to 5. Combinations of the above recited ranges are possible (e.g., each “z” is greater than or equal to 1 and less than or equal to 1,000, each “z” is greater than or equal to 400 and less than or equal to 600). Other ranges are also possible.

According to some embodiments, the greater the value of “z” is in the compound of Formula (IV), the more the additive will be prone to entanglement (e.g., with itself). Without wishing to be bound by theory, entanglement of the additive may provide an invisible fingerprint material having a lower coefficient of friction and a lower oleophobicity. The value of “z” in the compound of Formula (IV) may therefore be tuned depending on the particular application. In some embodiments, for example, if a lower coefficient of friction is desired, the value of “z” in the compound of Formula (IV) may be increased to promote entanglement, but if a higher oleophobicity is desired, the value of “z” in the compound of Formula (IV) may be decreased to impede entanglement.

According to certain embodiments, the additive comprises polydimethylsiloxane. In some embodiments, for example, the additive comprises a linear or branched compound of Formula (V):

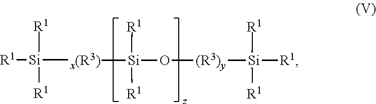

wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, OR², and —O—Si(R¹)₂—(R³)ₓ—[Si(CH₃)₂—O]_{z}—(R³)_{y}—Si(R¹)₃;
each R² is the same or different and is selected from the group consisting of hydrogen, deuterium, —C₁-C₁₀ alkyl, —C₂-C₁₀ alkenyl, and —C₃-C₁₀ alkynyl;
each R³ is the same of different and is selected from the group consisting of oxygen, —C₁-C₁₀ alkylene-, —C₂-C₁₀ alkenylene-, and —C₃-C₁₀ alkynylene-;
each x is independently greater than or equal to 0;
each y is independently less than or equal to 5; and
each z is independently greater than or equal to 1.

The value of each “x” in the compound of Formula (V) may be any of a variety of suitable values. In certain embodiments, for example, each “x” is greater than or equal to 0, greater than or equal to 1, greater than or equal to 2, greater than or equal to 5, greater than or equal to 10, greater than or equal to 20, or greater than or equal to 50. In some embodiments, each “x” is less than or equal to 100, less than or equal to 50, less than or equal to 20, less than or equal to 10, less than or equal to 5, or less than or equal to 1. Combinations of the above recited ranges are possible (e.g., each “x” is greater than or equal to 0 and less than or equal to 100, each “x” is greater than or equal to 5 and less than or equal to 10). Other ranges are also possible.

The value of each “y” in the compound of Formula (V) may be any of a variety of suitable values. In certain embodiments, for example, each “y” is less than or equal to 5, less than or equal to 4, less than or equal to 3, less than or equal to 2, or less than or equal to 1. In some embodiments, each “y” is greater than or equal to 0, greater than or equal to 1, greater than or equal to 2, greater than or equal to 3, or greater than or equal to 4. Combinations of the above recited ranges are possible (e.g., each “y” is less than or equal to 5 and greater than or equal to 0, each “y” is less than or equal to 3 and greater than or equal to 2). Other ranges are also possible.

The value of each “z” in the compound of Formula (V) may be any of a variety of suitable values. In certain embodiments, for example, each “z” is greater than or equal to 1, greater than or equal to 2, greater than or equal to 10, greater than or equal to 50, greater than or equal to 100, greater than or equal to 200, greater than or equal to 300, greater than or equal to 400, greater than or equal to 500, greater than or equal to 600, greater than or equal to 700, greater than or equal to 800, or greater than or equal to 900. In some embodiments, each “z” is less than or equal to 1,000, less than or equal to 900, less than or equal to 800, less than or equal to 700, less than or equal to 600, less than or equal to 500, less than or equal to 400, less than or equal to 300, less than or equal to 200, less than or equal to 100, less than or equal to 50, less than or equal to 10, or less than or equal to 5. Combinations of the above recited ranges are possible (e.g., each “z” is greater than or equal to 1 and less than or equal to 1,000, each “z” is greater than or equal to 400 and less than or equal to 600). Other ranges are also possible.

According to some embodiments, the greater the value of “z” is in the compound of Formula (V), the more the additive will be prone to entanglement (e.g., with itself). Without wishing to be bound by theory, entanglement of the additive may provide an invisible fingerprint material having a lower coefficient of friction and a lower oleophobicity. The value of “z” in the compound of Formula (V) may therefore be tuned depending on the particular application. In some embodiments, for example, if a lower coefficient of friction is desired, the value of “z” in the compound of Formula (V) may be increased to promote entanglement, but if a higher oleophobicity is desired, the value of “z” in the compound of Formula (V) may be decreased to impede entanglement.

According to certain embodiments, the additive comprises a linear or branched compound of Formula (VI):

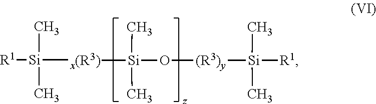

wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, OR², and —O—Si(CH₃)₂—(R³)ₓ—[Si(CH₃)₂—O]_{z}—(R³)_{y}—Si(CH₃)₂(R¹);
each R² is the same or different and is selected from the group consisting of hydrogen, deuterium, —C₁-C₁₀ alkyl, —C₂-C₁₀ alkenyl, and —C₃-C₁₀ alkynyl;
each R³ is the same of different and is selected from the group consisting of oxygen, —C₁-C₁₀ alkylene-, —C₂-C₁₀ alkenylene-, and —C₃-C₁₀ alkynylene-;
each x is independently greater than or equal to 0;
each y is independently less than or equal to 5; and
each z is independently greater than or equal to 1.

The value of each “x” in the compound of Formula (VI) may be any of a variety of suitable values. In certain embodiments, for example, each “x” is greater than or equal to 0, greater than or equal to 1, greater than or equal to 2, greater than or equal to 5, greater than or equal to 10, greater than or equal to 20, or greater than or equal to 50. In some embodiments, each “x” is less than or equal to 100, less than or equal to 50, less than or equal to 20, less than or equal to 10, less than or equal to 5, or less than or equal to 1. Combinations of the above recited ranges are possible (e.g., each “x” is greater than or equal to 0 and less than or equal to 100, each “x” is greater than or equal to 5 and less than or equal to 10). Other ranges are also possible.

The value of each “y” in the compound of Formula (VI) may be any of a variety of suitable values. In certain embodiments, for example, each “y” is less than or equal to 5, less than or equal to 4, less than or equal to 3, less than or equal to 2, or less than or equal to 1. In some embodiments, each “y” is greater than or equal to 0, greater than or equal to 1, greater than or equal to 2, greater than or equal to 3, or greater than or equal to 4. Combinations of the above recited ranges are possible (e.g., each “y” is less than or equal to 5 and greater than or equal to 0, each “y” is less than or equal to 3 and greater than or equal to 2). Other ranges are also possible.

The value of each “z” in the compound of Formula (VI) may be any of a variety of suitable values. In certain embodiments, for example, each “z” is greater than or equal to 1, greater than or equal to 2, greater than or equal to 10, greater than or equal to 50, greater than or equal to 100, greater than or equal to 200, greater than or equal to 300, greater than or equal to 400, greater than or equal to 500, greater than or equal to 600, greater than or equal to 700, greater than or equal to 800, or greater than or equal to 900. In some embodiments, each “z” is less than or equal to 1,000, less than or equal to 900, less than or equal to 800, less than or equal to 700, less than or equal to 600, less than or equal to 500, less than or equal to 400, less than or equal to 300, less than or equal to 200, less than or equal to 100, less than or equal to 50, less than or equal to 10, or less than or equal to 5. Combinations of the above recited ranges are possible (e.g., each “z” is greater than or equal to 1 and less than or equal to 1,000, each “z” is greater than or equal to 400 and less than or equal to 600). Other ranges are also possible.

According to some embodiments, the greater the value of “z” is in the compound of Formula (VI), the more the additive will be prone to entanglement (e.g., with itself). Without wishing to be bound by theory, entanglement of the additive may provide an invisible fingerprint material having a lower coefficient of friction and a lower oleophobicity. The value of “z” in the compound of Formula (VI) may therefore be tuned depending on the particular application. In some embodiments, for example, if a lower coefficient of friction is desired, the value of “z” in the compound of Formula (VI) may be increased to promote entanglement, but if a higher oleophobicity is desired, the value of “z” in the compound of Formula (VI) may be decreased to impede entanglement.

In certain embodiments, the additive comprises polyethylene glycol. In some embodiments, for example, the additive comprises a linear or branched compound of Formula (VII):

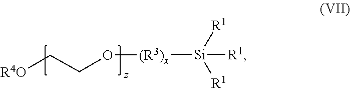

wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, OR², and —O—[(CH₂)₂—O]_{z}—(R³)ₓ—Si(R¹)₃,
each R² is the same or different and is selected from the group consisting of hydrogen, deuterium, —C₁-C₁₀ alkyl, —C₂-C₁₀ alkenyl, and —C₃-C₁₀ alkynyl,
each R³ is selected from the group consisting of oxygen, —C₁-C₁₀ alkylene-, —C₂-C₁₀ alkenylene-, and —C₃-C₁₀ alkynylene-,
R⁴ is selected from the group consisting of hydrogen, deuterium, —C₁-C₁₀ alkyl, —C₂-C₁₀ alkenyl, and —C₃-C₁₀ alkynyl,
each x is independently greater than or equal to 0; and
each z is independently greater than or equal to 1.

The value of each “x” in the compound of Formula (VII) may be any of a variety of suitable values. In certain embodiments, for example, each “x” is greater than or equal to 0, greater than or equal to 1, greater than or equal to 2, greater than or equal to 5, greater than or equal to 10, greater than or equal to 20, or greater than or equal to 50. In some embodiments, each “x” is less than or equal to 100, less than or equal to 50, less than or equal to 20, less than or equal to 10, less than or equal to 5, or less than or equal to 1. Combinations of the above recited ranges are possible (e.g., each “x” is greater than or equal to 0 and less than or equal to 100, each “x” is greater than or equal to 5 and less than or equal to 10). Other ranges are also possible.

The value of each “z” in the compound of Formula (VII) may be any of a variety of suitable values. In certain embodiments, for example, each “z” is greater than or equal to 1, greater than or equal to 2, greater than or equal to 10, greater than or equal to 50, greater than or equal to 100, greater than or equal to 200, greater than or equal to 300, greater than or equal to 400, greater than or equal to 500, greater than or equal to 600, greater than or equal to 700, greater than or equal to 800, or greater than or equal to 900. In some embodiments, each “z” is less than or equal to 1,000, less than or equal to 900, less than or equal to 800, less than or equal to 700, less than or equal to 600, less than or equal to 500, less than or equal to 400, less than or equal to 300, less than or equal to 200, less than or equal to 100, less than or equal to 50, less than or equal to 10, or less than or equal to 2. Combinations of the above recited ranges are possible (e.g., each “z” is greater than or equal to 1 and less than or equal to 1,000, each “z” is greater than or equal to 400 and less than or equal to 600). Other ranges are also possible.

In some embodiments, the greater the value of “z” is in the compound of Formula (VII), the more the additive will be prone to entanglement (e.g., with itself). Without wishing to be bound by theory, entanglement of the additive may provide an invisible fingerprint material having a lower coefficient of friction and a lower oleophobicity. The value of “z” in the compound of Formula (VII) may therefore be tuned depending on the particular application. In some embodiments, for example, if a lower coefficient of friction is desired, the value of “z” in the compound of Formula (VII) may be increased to promote entanglement, but if a higher oleophobicity is desired, the value of “z” in the compound of Formula (VII) may be decreased to impede entanglement.

The invisible fingerprint material may comprise the additive in any of a variety of suitable amounts. In some embodiments, for example, the invisible fingerprint material comprises the additive in an amount greater than or equal to 0.1 weight percent (wt. %), greater than or equal to 0.5 wt. %, greater than or equal to 1 wt. %, greater than or equal to 2 wt. %, greater than or equal to 3 wt. %, or greater than or equal to 4 wt. % versus the total weight of the invisible fingerprint material. In certain embodiments, the invisible fingerprint material comprises the additive in an amount less than or equal to 5 wt. %, less than or equal to 4 wt. %, less than or equal to 3 wt. %, less than or equal to 2 wt. %, less than or equal to 1 wt. %, or less than or equal to 0.5 wt. % versus the total weight of the invisible fingerprint material. Combinations of the above recited ranges are possible (e.g., the invisible fingerprint material comprises the additive in an amount greater than or equal to 0.1 wt. % and less than or equal to 5 wt. % versus the total weight of the invisible fingerprint material, the invisible fingerprint material comprises the additive in an amount greater than or equal to 0.5 wt. % and less than or equal to 1 wt. % versus the total weight of the invisible fingerprint material). Other ranges are also possible.

The additive may have any of a variety of suitable molecular weights. In certain embodiments, for example, the additive has a molecular weight of greater than or equal to 1,000 Da, greater than or equal to 2,000 Da, greater than or equal to 3,000 Da, greater than or equal to 5,000 Da, greater than or equal to 10,000 Da, greater than or equal to 20,000 Da, greater than or equal to 30,000 Da, or greater than or equal to 40,000 Da. In some embodiments, the additive has a molecular weight of less than or equal to 50,000 Da, less than or equal to 40,000 Da, less than or equal to 30,000 Da, less than or equal to 20,000 Da, less than or equal to 10,000 Da, less than or equal to 5,000 Da, less than or equal to 4,000 Da, less than or equal to 3,000 Da, or less than or equal to 2,000 Da. Combinations of the above recited ranges are possible (e.g., the additive has a molecular weight of greater than or equal to 1,000 Da and less than or equal to 50,000 Da, the additive has a molecular weight of greater than or equal to 20,000 Da and less than or equal to 30,000 Da). Other ranges are also possible. In some embodiments, the molecular weight of the additive is determined by gel permeation chromatography (GPC).

Without wishing to be bound by theory, the molecular weight of the additive may be inversely proportional to the coefficient of friction of the invisible fingerprint material and the number of hydrolysable moieties per weight-basis of the additive. The molecular weight of the additive may therefore be tuned depending on the particular application. In certain embodiments, for example, if a lower coefficient of friction is desired, the molecular weight of the additive may be increased, but if more hydrolysable moieties per weight-basis of the additive are desired (e.g., to increase longevity of the invisible fingerprint material), the molecular weight of the additive may be decreased.

According to some embodiments, a method of synthesizing a reaction product is described. In certain embodiments, the method comprises reacting one or more silane-containing crosslinking agents (e.g., one silane-containing crosslinking agent, two silane-containing crosslinking agents, three silane-containing crosslinking agents, etc.) with an additive to provide the reaction product. In certain embodiments wherein the method comprises reacting two or more silane-containing crosslinking agents with an additive, the two or more silane-containing crosslinking agents may be different (e.g., chemically different) species.

Reacting the one or more silane-containing crosslinking agents with the additive to provide the reaction product may occur at any of a variety of suitable temperatures. In certain embodiments, for example, reacting the one or more silane-containing crosslinking agents with the additive occurs at a temperature of greater than or equal to 20° C., greater than or equal to 30° C., greater than or equal to 40° C., greater than or equal to 50° C., greater than or equal to 60° C., greater than or equal to 70° C., greater than or equal to 80° C., or greater than or equal to 90° C. In some embodiments, reacting the one or more silane-containing crosslinking agents with the additive occurs at a temperature of less than or equal to 100° C., less than or equal to 90° C., less than or equal to 80° C., less than or equal to 70° C., less than or equal to 60° C., less than or equal to 50° C., less than or equal to 40° C., or less than or equal to 30° C. Combinations of the above recited ranges are possible (e.g., reacting the one or more silane-containing crosslinking agents with the additive occurs at a temperature of greater than or equal to 20° C. and less than or equal to 100° C., reacting the one or more silane-containing crosslinking agents with the additive occurs at a temperature of greater than or equal to 40° C. and less than or equal to 60° C.). Other ranges are also possible.

According to some embodiments, reacting the one or more silane-containing crosslinking agents with the additive to provide the reaction product may occur under reflux conditions, and the reaction temperature may depend on the particular solvent used for reflux.

Reacting the one or more silane-containing crosslinking agents with the additive to provide the reaction product may occur for any of a variety of suitable times. In certain embodiments, for example, reacting the one or more silane-containing crosslinking agents with the additive occurs for greater than or equal to 1 hour, greater than or equal to 5 hours, greater than or equal to 10 hours, greater than or equal to 15 hours, greater than or equal to 24 hours, greater than or equal to 48 hours, or greater than or equal to 72 hours. In some embodiments, reacting the one or more silane-containing crosslinking agents with the additive occurs for less than or equal to 96 hours, less than or equal to 72 hours, less than or equal to 48 hours, less than or equal to 24 hours, less than or equal to 15 hours, less than or equal to 10 hours, or less than or equal to 5 hours. Combinations of the above recited ranges are possible (e.g., reacting the one or more silane-containing crosslinking agents with the additive occurs for greater than or equal to 1 hour and less than or equal to 96 hours, reacting the one or more silane-containing crosslinking agents with the additive occurs for greater than or equal to 15 hours and less than or equal to 24 hours). Other ranges are also possible.

Reacting the one or more silane-containing crosslinking agents with the additive to provide the reaction product may occur in the presence of a catalyst. Any of a variety of suitable catalysts may be employed. In some embodiments, for example, the catalyst comprises potassium hydroxide (KOH), acetic acid (CH₃COOH), and/or combinations thereof. Other catalysts are also possible.

According to certain embodiments, the method comprises reacting at least two silane-containing crosslinking agents with each other to provide an intermediate. The intermediate may a hydrolysate, in accordance with certain embodiments.

Reacting the at least two silane-containing crosslinking agents with each other to provide the intermediate may occur at any of a variety of suitable temperatures. In certain embodiments, for example, reacting the at least two silane-containing crosslinking agents with each other occurs at a temperature of greater than or equal to 20° C., greater than or equal to 30° C., greater than or equal to 40° C., greater than or equal to 50° C., greater than or equal to 60° C., greater than or equal to 70° C., greater than or equal to 80° C., or greater than or equal to 90° C. In some embodiments, reacting the at least two silane-containing crosslinking agents with each other occurs at a temperature of less than or equal to 100° C., less than or equal to 90° C., less than or equal to 80° C., less than or equal to 70° C., less than or equal to 60° C., less than or equal to 50° C., less than or equal to 40° C., or less than or equal to 30° C. Combinations of the above recited ranges are possible (e.g., reacting the at least two silane-containing crosslinking agents with each other occurs at a temperature of greater than or equal to 20° C. and less than or equal to 100° C., reacting the at least two silane-containing crosslinking agents with each other occurs at a temperature of greater than or equal to 40° C. and less than or equal to 60° C.). Other ranges are also possible.

According to some embodiments, reacting the at least two silane-containing crosslinking agents with each other to provide the intermediate may occur under reflux conditions, and the reaction temperature may depend on the particular solvent used for reflux.

Reacting the at least two silane-containing crosslinking agents with each other to provide the intermediate may occur for any of a variety of suitable times. In certain embodiments, for example, reacting the at least two silane-containing crosslinking agents with each other occurs for greater than or equal to 1 hour, greater than or equal to 5 hours, greater than or equal to 10 hours, greater than or equal to 15 hours, greater than or equal to 24 hours, greater than or equal to 48 hours, or greater than or equal to 72 hours. In some embodiments, reacting the at least two silane-containing crosslinking agents with each other occurs for less than or equal to 96 hours, less than or equal to 72 hours, less than or equal to 48 hours, less than or equal to 24 hours, less than or equal to 15 hours, less than or equal to 10 hours, or less than or equal to 5 hours. Combinations of the above recited ranges are possible (e.g., reacting the at least two silane-containing crosslinking agents with each other occurs for greater than or equal to 1 hour and less than or equal to 96 hours, reacting the at least two silane-containing crosslinking agents with each other occurs for greater than or equal to 15 hours and less than or equal to 24 hours). Other ranges are also possible.

Reacting the at least two silane-containing crosslinking agents with each other to provide the intermediate may occur in the presence of a catalyst. Any of a variety of suitable catalysts may be employed. In some embodiments, for example, the catalyst comprises potassium hydroxide (KOH), acetic acid (CH₃COOH), and/or combinations thereof. Other catalysts are also possible.

In some embodiments, the method comprises reacting the intermediate with an additive to provide the reaction product. In some embodiments, the intermediate and the additive may be reacted in the presence of one or more silane-containing crosslinking agents to provide the reaction product.

Reacting the intermediate with the additive (and optionally one or more silane-containing crosslinking agents) to provide the reaction product may occur at any of a variety of suitable temperatures. In certain embodiments, for example, reacting the intermediate with the additive (and optionally one or more silane-containing crosslinking agents) occurs at a temperature of greater than or equal to 20° C., greater than or equal to 30° C., greater than or equal to 40° C., greater than or equal to 50° C., greater than or equal to 60° C., greater than or equal to 70° C., greater than or equal to 80° C., or greater than or equal to 90° C. In some embodiments, reacting the intermediate with the additive (and optionally one or more silane-containing crosslinking agents) occurs at a temperature of less than or equal to 100° C., less than or equal to 90° C., less than or equal to 80° C., less than or equal to 70° C., less than or equal to 60° C., less than or equal to 50° C., less than or equal to 40° C., or less than or equal to 30° C. Combinations of the above recited ranges are possible (e.g., reacting the intermediate with the additive (and optionally one or more silane-containing crosslinking agents) occurs at a temperature of greater than or equal to 20° C. and less than or equal to 100° C., reacting the intermediate with the additive (and optionally one or more silane-containing crosslinking agents) occurs at a temperature of greater than or equal to 40° C. and less than or equal to 60° C.). Other ranges are also possible.

According to some embodiments, reacting the intermediate with the additive (and optionally one or more silane-containing crosslinking agents) to provide the reaction product may occur under reflux conditions, and the reaction temperature may depend on the particular solvent used for reflux.

Reacting the intermediate with the additive (and optionally one or more silane-containing crosslinking agents) to provide the reaction product may occur for any of a variety of suitable times. In certain embodiments, for example, reacting the intermediate with the additive (and optionally one or more silane-containing crosslinking agents) occurs for greater than or equal to 1 hour, greater than or equal to 5 hours, greater than or equal to 10 hours, greater than or equal to 15 hours, greater than or equal to 24 hours, greater than or equal to 48 hours, or greater than or equal to 72 hours. In some embodiments, reacting the intermediate with the additive (and optionally one or more silane-containing crosslinking agents) occurs for less than or equal to 96 hours, less than or equal to 72 hours, less than or equal to 48 hours, less than or equal to 24 hours, less than or equal to 15 hours, less than or equal to 10 hours, or less than or equal to 5 hours. Combinations of the above recited ranges are possible (e.g., reacting the intermediate with the additive (and optionally one or more silane-containing crosslinking agents) occurs for greater than or equal to 1 hour and less than or equal to 96 hours, reacting the intermediate with the additive (and optionally one or more silane-containing crosslinking agents) occurs for greater than or equal to 15 hours and less than or equal to 24 hours). Other ranges are also possible.

Reacting the intermediate with the additive (and optionally one or more silane-containing crosslinking agents) to provide the reaction product may occur in the presence of a catalyst. Any of a variety of suitable catalysts may be employed. In some embodiments, for example, the catalyst comprises potassium hydroxide (KOH), acetic acid (CH₃COOH), and/or combinations thereof. Other catalysts are also possible.

As described herein, the invisible fingerprint material comprises a reaction product of one or more silane-containing crosslinking agents (e.g., one silane-containing crosslinking agent, two silane-containing crosslinking agents, three silane-containing crosslinking agents, etc.) and an additive, in accordance with certain embodiments.

According to certain embodiments, the reaction product is a hydrolysate. As used herein, the term “hydrolysate” is given its ordinary meaning in the art and refers to a product of hydrolysis. In some embodiments, the reaction product may be hydrolyzed to provide the hydrolysate during the synthesis of the reaction product due to the presence of water, a catalyst, an acid, and/or a base during the synthesis. In certain embodiments, one or more components of the reaction product (e.g., one or more silane-containing crosslinking agents and/or the additive) may be hydrolyzed to provide the hydrolysate during the synthesis of the reaction product due to the presence of water, a catalyst, an acid, and/or a base during the synthesis.

In certain embodiments, the reaction product may comprise some or all of Blocks (A)-(D):

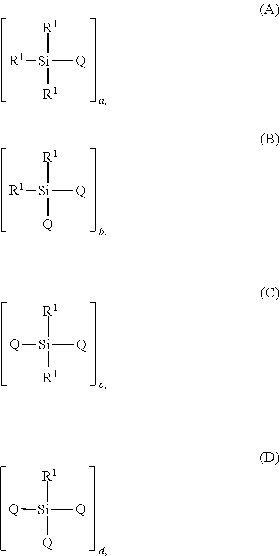

wherein:
each Q is the same or different and is selected from the group consisting of —H, —OH, —O—(CH₂—CH₂)ₙ-Q, —O—(CH₂—CH₂)ₙ—OH, or an oxygen that is combined with another Q of Blocks (A), (B), (C), or (D) to link two silicon atoms,
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, and OR²,
each R² is the same or different and is selected from the group consisting of hydrogen, deuterium, —C₁-C₁₀ alkyl, —C₂-C₁₀ alkenyl, and —C₃-C₁₀ alkynyl,
each n is independently greater than or equal to 1, and
a, b, c, and d are each independently greater than or equal to 1.

The value of each “n” in Blocks (A), (B), (C), and (D) may be any of a variety of suitable values. In certain embodiments, for example, each “n” is greater than or equal to 1, greater than or equal to 2, greater than or equal to 10, greater than or equal to 50, greater than or equal to 100, greater than or equal to 200, greater than or equal to 300, greater than or equal to 400, greater than or equal to 500, greater than or equal to 600, greater than or equal to 700, greater than or equal to 800, or greater than or equal to 900. In some embodiments, each “n” is less than or equal to 1,000, less than or equal to 900, less than or equal to 800, less than or equal to 700, less than or equal to 600, less than or equal to 500, less than or equal to 400, less than or equal to 300, less than or equal to 200, less than or equal to 100, less than or equal to 50, less than or equal to 10, or less than or equal to 2. Combinations of the above recited ranges are possible (e.g., each “n” is greater than or equal to 1 and less than or equal to 1,000, each “n” is greater than or equal to 400 and less than or equal to 600). Other ranges are also possible.

The value of “a”, “b”, “c”, and “d” in Blocks (A), (B), (C), and (D), respectively, may be any of a variety of suitable values. In certain embodiments, for example, “a”, “b”, “c”, and/or “d” is greater than or equal to 1, greater than or equal to 2, greater than or equal to 10, greater than or equal to 50, greater than or equal to 100, greater than or equal to 200, greater than or equal to 300, greater than or equal to 400, greater than or equal to 500, greater than or equal to 600, greater than or equal to 700, greater than or equal to 800, or greater than or equal to 900. In some embodiments, “a”, “b”, “c”, and/or “d” is less than or equal to 1,000, less than or equal to 900, less than or equal to 800, less than or equal to 700, less than or equal to 600, less than or equal to 500, less than or equal to 400, less than or equal to 300, less than or equal to 200, less than or equal to 100, less than or equal to 50, less than or equal to 10, or less than or equal to 2. Combinations of the above recited ranges are possible (e.g., “a”, “b”, “c”, and/or “d” is greater than or equal to 1 and less than or equal to 1,000, “a”, “b”, “c”, and/or “d” is greater than or equal to 400 and less than or equal to 600). Other ranges are also possible.

According to certain embodiments, some or all of Blocks (A)-(D) are present in the reaction product. As a non-limiting example, blocks (A), (C), and (D) can combine to form exemplary structure (1):

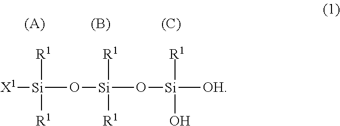

Although exemplary structure (1) shown above is linear as shown, some or all of Blocks (A)-(D) can combine in a three-dimensional shape to form a branched structure, in accordance with certain embodiments. As a non-limiting example, blocks (A), (B), (C), and (D) can combine to form exemplary structure (2):

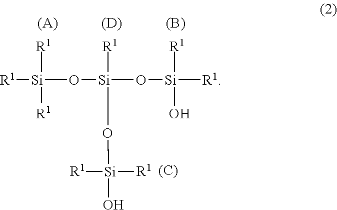

According to some embodiments, the reaction product contains linear stretches of blocks selected from the group consisting of Blocks (A), (B), (C), (D), and combinations thereof, and/or branched segments of blocks selected from the group consisting of Blocks (A), (B), (C), (D) and combinations thereof.

The reaction product may have any of a variety of suitable molecular weights. In certain embodiments, for example, the reaction product has a molecular weight of greater than or equal to 1,000 Da, greater than or equal to 10,000 Da, greater than or equal to 20,000 Da, greater than or equal to 30,000 Da, greater than or equal to 40,000 Da, greater than or equal to 50,000 Da, greater than or equal to 60,000 Da, greater than or equal to 70,000 Da, greater than or equal to 80,000 Da, greater than or equal to 90,000 Da, greater than or equal to 100,000 Da, greater than or equal to 200,000 Da, greater than or equal to 300,000 Da, or greater than or equal to 400,000 Da. In some embodiments, the reaction product has a molecular weight of less than or equal to 500,000 Da, less than or equal to 400,000 Da, less than or equal to 300,000 Da, less than or equal to 200,000 Da, less than or equal to 100,000 Da, less than or equal to 90,000 Da, less than or equal to 80,000 Da, less than or equal to 70,000 Da, less than or equal to 60,000 Da, less than or equal to 50,000 Da, less than or equal to 40,000 Da, less than or equal to 30,000 Da, less than or equal to 20,000 Da, less than or equal to 10,000 Da, or less than or equal to 5,000 Da. Combinations of the above recited ranges are possible (e.g., the reaction product has a molecular weight of greater than or equal to 1,000 Da and less than or equal to 500,000 Da, the reaction product has a molecular weight of greater than or equal to 40,000 Da and less than or equal to 60,000 Da). Other ranges are also possible. In some embodiments, the molecular weight of the reaction product is determined by gel permeation chromatography (GPC).

According to certain embodiments, at least a portion of the composition comprising the invisible fingerprint material is immobilized on at least the portion of the at least one surface of the substrate. Referring to FIG. 1, for example, at least a portion of composition 130 is immobilized on at least the portion of at least one surface 120 of substrate 110. In some embodiments, for example, at least a portion of composition 130 is chemically bound (e.g., covalently bound, non-covalently bound) to at least the portion of at least one surface 120 of substrate 110. Examples of bonding interactions include, in some embodiments, covalent bonds, ionic bonds, van der Waals forces, hydrogen bonding, dipole interactions, coordination, chelation, and the like. In certain embodiments, at least a portion of composition is immobilized on at least the portion of the at least one surface of the substrate via at least one —Si—O— linkage.

According to certain embodiments, the substrate is optically transparent. The substrate may have any of a variety of suitable percent optical transmittances. In some embodiments, for example, the percent optical transmittance of the substrate is greater than or equal to 90%, greater than or equal to 92%, greater than or equal to 94%, greater than or equal to 96%, greater than or equal to 98%, or greater than or equal to 99%. In some embodiments, the percent optical transmittance of the substrate is less than or equal to 100%, less than or equal to 99%, less than or equal to 98%, less than or equal to 96%, less than or equal to 94%, or less than or equal to 92%. Combinations of the above recited ranges are possible (e.g., the percent optical transmittance of the substrate is greater than or equal to 90% and less than or equal to 100%, the percent optical transmittance of the substrate is greater than or equal to 98% and less than or equal to 99%). Other ranges are also possible. According to certain embodiments, the percent optical transmittance of the substrate is determined using a spectrophotometer.

The substrate may comprise any of a variety of suitable materials. In certain embodiments, for example, the substrate comprises glass, a ceramic, a metal, a metal oxide, a polymer (e.g., an acrylic polymer, a plastic), an electronic component (e.g., a silicon wafer), and/or combinations thereof. Other materials are also possible.

In certain embodiments, the substrate may comprise an initial coating (e.g., a coating comprising vinyl groups, such as a vinyl primer). Other initial coatings are also possible.

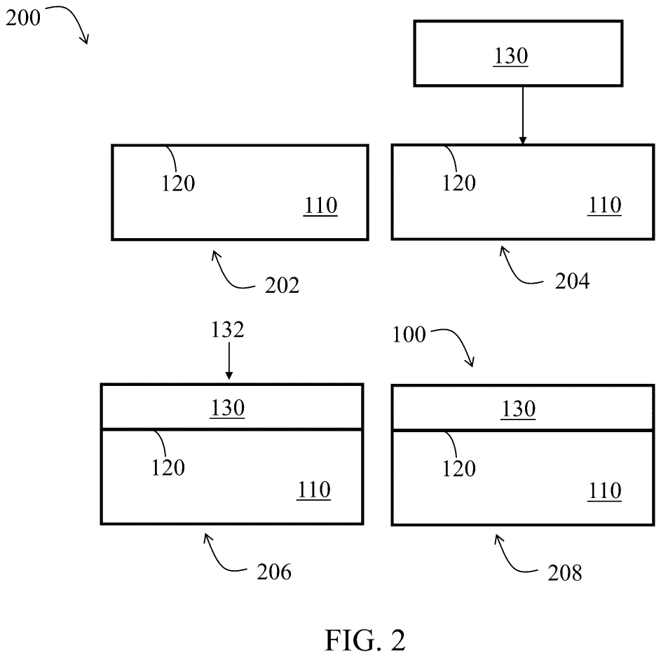

According to certain embodiments, a method of coating a substrate is described. FIG. 2 shows, according to some embodiments, a schematic diagram of an exemplary method of coating a substrate.

In some embodiments, step 202 of method 200 comprises providing substrate 110 comprising at least one surface 120. According to some embodiments, the method comprises activating at least a portion the substrate. In certain embodiments, for example, the substrate is activated by exposing the substrate to a plasma of inert gas, such as, but not limited to, argon (Ar), neon (Ne), helium (He), nitrogen (N₂), oxygen (O₂), water (H₂O), and/or mixtures thereof. In certain embodiments, the substrate is activated by corona treatment. In some embodiments, the substrate is activated by mechanically treating the surface with a metal oxide. In certain embodiments, the substrate is activated by acid etching (e.g., with piranha solution (a mixture of sulfuric acid and hydrogen peroxide), hydrofluoric acid, and/or hydrochloric acid). Without wishing to be bound by theory, as a result of activating the substrate, the density of hydroxyl (—OH) moieties on the surface of the substrate is increased, thereby facilitating immobilization (e.g., bonding) of at least a portion of the composition on the surface of the substrate, as explained in greater detail herein.

Step 204 of method 200 comprises, in accordance with certain embodiments, disposing (e.g., depositing) composition 130 (e.g., invisible fingerprint material) on at least a portion of at least one surface 120 of substrate 110 such that composition 130 coats at least the portion of at least one surface 120 of substrate 110. In certain embodiments, as explained herein in greater detail, as a result of disposing the composition on at least a portion of the at least one surface of the substrate, at least a portion of the composition may be immobilized (e.g., bound) to the surface of the substrate, as explained in greater detail herein.

According to some embodiments, although not shown in the figures, the composition may be disposed (e.g., deposited) on at least a portion of more than one surface of the substrate (e.g., two surfaces of the substrate, three surfaces of the substrate, four surfaces of the substrate, etc.).

Depositing the composition (e.g., invisible fingerprint material) on at least the portion of the at least one surface of the substrate may comprise any of a variety of suitable deposition methods. According to certain embodiments, for example, depositing the composition comprises spraying (e.g., spray coating), spinning (e.g., spin coating), dipping (e.g., dip coating), wiping, chemical vapor deposition (CVD), physical vapor deposition (PVD), and/or combinations thereof.

Step 206 of method 200 comprises, in some embodiments, applying heat 132 to composition 130 (e.g., invisible fingerprint material) after depositing composition 130 on at least the portion of at least one surface 120 of substrate 110. In certain embodiments, for example, applying heat to the composition comprises curing and/or annealing the composition. Other methods of applying heat to the composition are also possible.

According to some embodiments, applying heat 132 to composition 130 disposed on at least the portion of at least one surface 120 of substrate 110 results in article 100, as shown in step 208 of method 200.

The composition (e.g., invisible fingerprint material) may be heated (e.g., cured) to any of a variety of suitable temperatures. In some embodiments, for example, the composition is heated to a temperature of greater than or equal to 25° C., greater than or equal to 50° C., greater than or equal to 75° C., greater than or equal to 100° C., greater than or equal to 110° C., greater than or equal to 120° C., greater than or equal to 130° C., or greater than or equal to 140° C. In certain embodiments, the composition is heated to a temperature of less than or equal to 150° C., less than or equal to 140° C., less than or equal to 130° C., less than or equal to 120° C., less than or equal to 110° C., less than or equal to 100° C., less than or equal to 75° C., or less than or equal to 50° C. Combinations of the above recited ranges are possible (e.g., the composition is heated to a temperature of greater than or equal to 25° C. and less than or equal to 150° C., the composition is heated to a temperature of greater than or equal to 120° C. and less than or equal to 140° C.). Other ranges are also possible.

The composition (e.g., invisible fingerprint material) may be heated (e.g., cured) to any of the aforementioned temperatures for any of a variety of suitable times. In certain embodiments, for example, the composition is heated for greater than or equal to 1 minute, greater than or equal to 30 minutes, greater than or equal to 1 hour, greater than or equal to 5 hours, greater than or equal to 10 hours, greater than or equal to 24 hours, greater than or equal to 48 hours, or greater than or equal to 72 hours. In some embodiments, the composition is heated for less than or equal to 96 hours, less than or equal to 72 hours, less than or equal to 48 hours, less than or equal to 24 hours, less than or equal to 10 hours, less than or equal to 5 hours, less than or equal to 1 hour, or less than or equal to 30 minutes. Combinations of the above recited ranges are possible (e.g., the composition is heated for greater than or equal to 1 minute and less than or equal to 96 hours, the composition is heated for greater than or equal to 10 hours and less than or equal to 24 hours). Other ranges are also possible.

In some embodiments, the amount of time that the composition (e.g., invisible fingerprint material) is heated (e.g., cured) depends on the temperature at which the composition is heated. In certain embodiments, for example, higher heating temperatures (e.g., greater than or equal to 100° C.) are associated with shorter heating times (e.g., less than or equal to 1 hour).

In some embodiments, lower heating temperatures (e.g., less than or equal to 75° C.) are associated with longer heating times (e.g., greater than or equal to 5 hours).

In certain embodiments, the amount of time that the composition (e.g., invisible fingerprint material) is heated (e.g., cured) and/or the temperature at which the composition is heated depends on the substrate on which the composition is disposed (e.g., deposited). In certain embodiments, for example, higher heating temperatures (e.g., greater than or equal to 100° C.) and shorter heating times (e.g., less than or equal to 1 hour) are associated with compositions disposed on glass substrates. In some embodiments, lower heating temperatures (e.g., less than or equal to 75° C.) and longer heating times (e.g., greater than or equal to 5 hours) are associated with compositions disposed on polymer (e.g., plastic) substrates.

According to certain embodiments, the coating comprising the invisible fingerprint material may be hydrophobic. The coating comprising the invisible fingerprint material may have any of a variety of suitable water contact angles. In some embodiments, for example, the coating comprising the invisible fingerprint material has a water contact angle of greater than or equal to 80°, greater than or equal to 85°, greater than or equal to 90°, greater than or equal to 95°, greater than or equal to 100°, greater than or equal to 105°, greater than or equal to 110°, greater than or equal to 115°, greater than or equal to 120°, greater than or equal to 125°, greater than or equal to 130°, greater than or equal to 135°, greater than or equal to 140°, greater than or equal to 145°, greater than or equal to 150°, greater than or equal to 155°, greater than or equal to 160°, greater than or equal to 165°, greater than or equal to 170°, or greater than or equal to 175°. In some embodiments, the coating comprising the invisible fingerprint material has a water contact angle of less than or equal to 180°, less than or equal to 175°, less than or equal to 170°, less than or equal to 165°, less than or equal to 160°, less than or equal to 155°, less than or equal to 150°, less than or equal to 145°, less than or equal to 140°, less than or equal to 135°, less than or equal to 130°, less than or equal to 125°, less than or equal to 120°, less than or equal to 115°, less than or equal to 110°, less than or equal to 105°, less than or equal to 100°, less than or equal to 95°, less than or equal to 90°, or less than or equal to 85°. Combinations of the above recited ranges are possible (e.g., the coating comprising the invisible fingerprint material has a water contact angle of greater than or equal to 80° and less than or equal to 180°, the coating comprising the invisible fingerprint material has a water contact angle of greater than or equal to 130° and less than or equal to 140°). Other ranges are also possible. In certain embodiments, the water contact angle of the coating comprising the invisible fingerprint material is determined using a goniometer.

In certain embodiments, the coating comprising the invisible fingerprint material may be oleophilic. The coating comprising the invisible fingerprint material may have any of a variety of suitable diiodomethane contact angles. In certain embodiments, for example, the coating comprising the invisible fingerprint material has a diiodomethane contact angle of greater than or equal to 1°, greater than or equal to 5°, greater than or equal to 10°, greater than or equal to 15°, greater than or equal to 20°, greater than or equal to 25°, greater than or equal to 30°, greater than or equal to 35°, or greater than or equal to 40°. In some embodiments, the coating comprising the invisible fingerprint material has a diiodomethane contact angle of less than or equal to 45°, less than or equal to 40°, less than or equal to 35°, less than or equal to 30°, less than or equal to 25°, less than or equal to 20°, less than or equal to 15°, less than or equal to 10°, or less than or equal to 5°. Combinations of the above recited ranges are possible (e.g., the coating comprising the invisible fingerprint material has a diiodomethane contact angle of greater than or equal to 1° and less than or equal to 45°, the coating comprising the invisible fingerprint material has a diiodomethane contact angle of greater than or equal to 25° and less than or equal to 30°). Other ranges are also possible. In certain embodiments, the diiodomethane contact angle of the coating comprising the invisible fingerprint material is determined using a goniometer.

Conventional substrates and coatings disposed thereon are subject to mechanical abrasion, which degrades, wears away, and/or otherwise diminishes the coating thickness, transparency, and/or effectiveness of the coating overtime. Abrasion occurs during substrate handling by the user, such as by rubbing with a cloth to remove unwanted materials (e.g., to remove dirt), which is periodically necessary for restoring satisfactory visibility through the coating. In some embodiments, degradation may result from exposure to ultraviolet radiation, heat, cold, chemicals, salts and/or other corrosive materials, dirt, other abrasive materials, and/or other environmental elements, conditions, and/or materials.

In certain embodiments, the coating (e.g., anti-fingerprint coating) may be durable. In some embodiments, for example, the coating has a particular abrasion resistance as measured by the water contact angle and/or the diiodomethane contact angle after a certain number of abrasions. In certain embodiments, the abrasion method is based off a linear abrader setup using eraser abrasion. In some embodiments, for example, the abrasion method is based off ASTM D1044.

According to certain embodiments, the water contact angle of the coating comprising the invisible fingerprint material may decrease by any of a variety of suitable percentages after a number of linear abrasion cycles (e.g., after 3,000 linear abrasion cycles, 4,000 linear abrasion cycles, 5,000 linear abrasion cycles). In some embodiments, for example, the water contact angle of the coating comprising the invisible fingerprint material decreases by less than or equal to 50%, less than or equal to 45%, less than or equal to 40%, less than or equal to 35%, less than or equal to 30%, less than or equal to 25%, less than or equal to 20%, or less than or equal to 15% after 3,000 linear abrasion cycles, after 4,000 linear abrasion cycles, and/or after 5,000 linear abrasion cycles. In certain embodiments, the water contact angle of the coating comprising the invisible fingerprint material decreases by greater than or equal to 10%, greater than or equal to 15%, greater than or equal to 20%, greater than or equal to 25%, greater than or equal to 30%, greater than or equal to 35%, greater than or equal to 40%, or greater than or equal to 45% after 3,000 linear abrasion cycles, 4,000 linear abrasion cycles, and/or 5,000 linear abrasion cycles. Combinations of the above recited ranges are possible (e.g., the water contact angle of the coating comprising the invisible fingerprint material decreases by less than or equal to 50% and greater than or equal to 10% after 3,000 linear abrasion cycles, 4,000 linear abrasion cycles, and/or 5,000 linear abrasion cycles, the water contact angle of the coating comprising the invisible fingerprint material decreases by less than or equal to 30% and greater than or equal to 20% after 3,000 linear abrasion cycles, 4,000 linear abrasion cycles, and/or 5,000 linear abrasion cycles). Other ranges are also possible.

In certain embodiments, the coating comprising the invisible fingerprint material may have any of a variety of suitable water contact angles after a number of linear abrasion cycles (e.g., after 3,000 linear abrasion cycles, 4,000 linear abrasion cycles, 5,000 linear abrasion cycles). In some embodiments, for example, the coating comprising the invisible fingerprint material has a water contact angle of greater than or equal to 40°, greater than or equal to 45°, greater than or equal to 50°, greater than or equal to 55°, greater than or equal to 60°, greater than or equal to 65°, greater than or equal to 70°, greater than or equal to 75°, greater than or equal to 80°, greater than or equal to 85°, greater than or equal to 90°, greater than or equal to 95°, greater than or equal to 100°, greater than or equal to 105°, greater than or equal to 110°, greater than or equal to 115°, greater than or equal to 120°, greater than or equal to 125°, greater than or equal to 130°, greater than or equal to 135°, greater than or equal to 140°, greater than or equal to 145°, greater than or equal to 150°, greater than or equal to 155°, or greater than or equal to 160° after 3,000 linear abrasion cycles, 4,000 linear abrasion cycles, and/or 5,000 linear abrasion cycles. In some embodiments, the coating comprising the invisible fingerprint material has a water contact angle of less than or equal to 165°, less than or equal to 160°, less than or equal to 155°, less than or equal to 150°, less than or equal to 145°, less than or equal to 140°, less than or equal to 135°, less than or equal to 130°, less than or equal to 125°, less than or equal to 120°, less than or equal to 115°, less than or equal to 110°, less than or equal to 105°, less than or equal to 100°, less than or equal to 95°, less than or equal to 90°, less than or equal to 85°, less than or equal to 80°, less than or equal to 75°, less than or equal to 70°, less than or equal to 65°, less than or equal to 60°, less than or equal to 55°, less than or equal to 50°, or less than or equal to 45° after 3,000 linear abrasion cycles, 4,000 linear abrasion cycles, and/or 5,000 linear abrasion cycles. Combinations of the above recited ranges are possible (e.g., the coating comprising the invisible fingerprint material has a water contact angle of greater than or equal to 40° and less than or equal to 165° after 3,000 linear abrasion cycles, 4,000 linear abrasion cycles, and/or 5,000 linear abrasion cycles, the coating comprising the invisible fingerprint material has a water contact angle of greater than or equal to 100° and less than or equal to 120° after 3,000 linear abrasion cycles, 4,000 linear abrasion cycles, and/or 5,000 linear abrasion cycles). Other ranges are also possible. In certain embodiments, the water contact angle of the coating comprising the invisible fingerprint material after a number of abrasion cycles (e.g., 3,000 abrasion cycles, 4,000 abrasion cycles, 5,000 abrasion cycles) is determined using a goniometer.

According to some embodiments, the diiodomethane contact angle of the coating comprising the invisible fingerprint material may increase by any of a variety of suitable percentages after a number of linear abrasion cycles (e.g., after 3,000 linear abrasion cycles, 4,000 linear abrasion cycles, 5,000 linear abrasion cycles). In some embodiments, for example, the diiodomethane contact angle of the coating comprising the invisible fingerprint material increases by greater than or equal to 10%, greater than or equal to 15%, greater than or equal to 20%, greater than or equal to 25%, greater than or equal to 30%, greater than or equal to 35%, or greater than or equal to 40%, or greater than or equal to 45% after 3,000 linear abrasion cycles, 4,000 linear abrasion cycles, and/or 5,000 linear abrasion cycles. In certain embodiments, the diiodomethane contact angle of the coating comprising the invisible fingerprint material increases by less than or equal to 50%, less than or equal to 45%, less than or equal to 40%, less than or equal to 35%, less than or equal to 30%, less than or equal to 25%, less than or equal to 20%, or less than or equal to 15% after 3,000 linear abrasion cycles, 4,000 linear abrasion cycles, and/or 5,000 linear abrasion cycles. Combinations of the above recited ranges are possible (e.g., the diiodomethane contact angle of the coating comprising the invisible fingerprint material increases by greater than or equal to 10% and less than or equal to 50% after 3,000 linear abrasion cycles, 4,000 linear abrasion cycles, and/or 5,000 linear abrasion cycles, the diiodomethane contact angle of the coating comprising the invisible fingerprint material increases by greater than or equal to 25% and less than or equal to 30% after 3,000 linear abrasion cycles, 4,000 linear abrasion cycles, and/or 5,000 linear abrasion cycles). Other ranges are also possible.

According to some embodiments, the coating comprising the invisible fingerprint material may have any of a variety of suitable diiodomethane contact angles after a number of linear abrasion cycles (e.g., after 3,000 linear abrasion cycles, 4,000 linear abrasion cycles, 5,000 linear abrasion cycles). In certain embodiments, for example, the coating comprising the invisible fingerprint material has a diiodomethane contact angle of greater than or equal to 1°, greater than or equal to 5°, greater than or equal to 10°, greater than or equal to 15°, greater than or equal to 20°, greater than or equal to 25°, greater than or equal to 30°, greater than or equal to 35°, greater than or equal to 40°, greater than or equal to 45°, greater than or equal to 50°, greater than or equal to 55°, greater than or equal to 60°, or greater than or equal to 65° after 3,000 linear abrasion cycles, 4,000 linear abrasion cycles, and/or 5,000 linear abrasion cycles. In some embodiments, the coating comprising the invisible fingerprint material has a diiodomethane contact angle of less than or equal to 70°, less than or equal to 65°, less than or equal to 60°, less than or equal to 55°, less than or equal to 50°, less than or equal to 45°, less than or equal to 40°, less than or equal to 35°, less than or equal to 30°, less than or equal to 25°, less than or equal to 20°, less than or equal to 15°, less than or equal to 10°, or less than or equal to 5°, after 3,000 linear abrasion cycles, 4,000 linear abrasion cycles, and/or 5,000 linear abrasion cycles. Combinations of the above recited ranges are possible (e.g., the coating comprising the invisible fingerprint material has a diiodomethane contact angle of greater than or equal to 1° and less than or equal to 70° after 3,000 linear abrasion cycles, 4,000 linear abrasion cycles, and/or 5,000 linear abrasion cycles, the coating comprising the invisible fingerprint material has a diiodomethane contact angle of greater than or equal to 25° and less than or equal to 30° after 3,000 linear abrasion cycles, 4,000 linear abrasion cycles, and/or 5,000 linear abrasion cycles). Other ranges are also possible. In certain embodiments, the diiodomethane contact angle of the coating comprising the invisible fingerprint material after 3,000 linear abrasion cycles, 4,000 linear abrasion cycles, and/or 5,000 linear abrasion cycles is determined using a goniometer.

According to certain embodiments, the coating comprising the invisible fingerprint material is lubricious. The coating comprising the invisible fingerprint material may have any of a variety of suitable coefficient of friction values. Without wishing to be bound by theory, the coefficient of friction value may be inversely proportional to the amount of additive incorporated into the invisible fingerprint material, such that the more additive included in the invisible fingerprint material, the lower the coefficient of friction.

In certain embodiments, the coating comprising the invisible fingerprint material has a coefficient of friction of greater than or equal to 0.01, greater than or equal to 0.02, greater than or equal to 0.03, greater than or equal to 0.04, greater than or equal to 0.05, greater than or equal to 0.06, greater than or equal to 0.07, greater than or equal to 0.08, or greater than or equal to 0.09. In some embodiments, the coating comprising the invisible fingerprint material has a coefficient of friction of less than or equal to 0.1, less than or equal to 0.09, less than or equal to 0.08, less than or equal to 0.07, less than or equal to 0.06, less than or equal to 0.05, less than or equal to 0.04, less than or equal to 0.03, or less than or equal to 0.02. Combinations of the above recited ranges are possible (e.g., the coating comprising the invisible fingerprint material has a coefficient of friction of greater than or equal to 0.01 and less than or equal to 0.1, the coating comprising the invisible fingerprint material has a coefficient of friction of greater than or equal to 0.04 and less than or equal to 0.06). Other ranges are also possible. According to some embodiments, the coefficient of friction of the coating comprising the invisible fingerprint material is determined using a portable friction meter muse.

According to certain embodiments, the coefficient of friction of the coating comprising the invisible fingerprint material is reduced as compared to a comparative coefficient of friction of a comparative coating that does not include the additive but is otherwise equivalent. The percent reduction in the coefficient of friction of the coating comprising the invisible fingerprint material as compared to the comparative coefficient of friction of the comparative coating that does not include the additive but is otherwise equivalent may be any of a variety of suitable values. In certain embodiments, for example, the percent reduction in the coefficient of friction of the coating comprising the invisible fingerprint material as compared to the comparative coefficient of friction of the comparative composition that does not include the additive but is otherwise equivalent is greater than or equal to 20%, greater than or equal to 25%, or greater than or equal 30%. In some embodiments, the percent reduction in the coefficient of friction of the coating comprising the invisible fingerprint material as compared to the comparative coefficient of friction of the comparative composition that does not include the additive but is otherwise equivalent is less than or equal to 35%, less than or equal to 30%, or less than or equal to 25%. Combinations of the above recited ranges are possible (e.g., the percent reduction in the coefficient of friction of the coating comprising the invisible fingerprint material as compared to the comparative coefficient of friction of the comparative composition that does not include the additive but is otherwise equivalent is greater than or equal to 20% and less than or equal to 35%, the percent reduction in the coefficient of friction of the coating comprising the invisible fingerprint material as compared to the comparative coefficient of friction of the comparative composition that does not include the additive but is otherwise equivalent is greater than or equal to 25% and less than or equal to 30%). Other ranges are also possible.

In certain embodiments, the coating comprising the invisible fingerprint material may be optically transparent. The coating comprising the invisible fingerprint material may have any of a variety of suitable percent optical transmittances. In certain embodiments, for example, the percent optical transmittance of the coating comprising the invisible fingerprint material is greater than or equal to 90%, greater than or equal to 92%, greater than or equal to 94%, greater than or equal to 96%, greater than or equal to 98%, or greater than or equal to 99%. In some embodiments, the percent optical transmittance of the coating comprising the invisible fingerprint material is less than or equal to 100%, less than or equal to 99%, less than or equal to 98%, less than or equal to 96%, less than or equal to 94%, or less than or equal to 92%. Combinations of the above recited ranges are possible (e.g., the percent optical transmittance of the coating comprising the invisible fingerprint material is greater than or equal to 90% and less than or equal to 100%, the percent optical transmittance of the coating comprising the invisible fingerprint material is greater than or equal to 94% and less than or equal to 96%). Other ranges are also possible. According to certain embodiments, the percent optical transmittance of the comprising the invisible fingerprint material is determined using a spectrophotometer.

According to certain embodiments, a kit is described, the kit comprising an invisible fingerprint material (e.g., a non-fluorinated invisible fingerprint material). In some embodiments, the invisible fingerprint material comprises one or more silane-containing crosslinking agents and an additive, as described herein. In certain embodiments, the invisible fingerprint material may be provided as a solid, and the kit may comprise one or more solvents configured to dissolve the invisible fingerprint material. In other embodiments, the kit may comprise one or more silane-containing crosslinking agents provided as a solid, an additive provided as a solid, and one or more solvents configured to dissolve the one or more silane-containing crosslinking agents and the additive. In yet other embodiments, the kit may comprise one or more solutions comprising the invisible fingerprint material. For example, in certain embodiments, the kit may comprise the invisible fingerprint material pre-dissolved in one or more solvents and ready for application onto a surface of a substrate.

As described herein, the composition (e.g., invisible fingerprint material) may be coated on a substrate comprising a transparent material, such as glass or plastic. According to certain embodiments, the coated substrate may be suitable for use as an article in transportation vehicles and/or equipment. For example, articles for use in transportation vehicles and/or equipment include, but are not limited to, exterior parts of an automobile, aircraft, watercraft, and/or train, such as outer plates, window glass (e.g., windshield, side windows, rear windows, sunroof), mirrors, and/or display panels, and interior parts of an automobile, aircraft, watercraft, and/or train, such as instrument panels and/or displays. In some embodiments, the coated substrate may be suitable for use as an article in building equipment. For example, articles for use in building equipment include, but are not limited to, furniture, base materials (e.g., glass plates or glass windows for roofs, doors, partitions, and/or greenhouses), transparent plastic plates or windows to be used instead of or in addition to glass, and wall materials (e.g., ceramics, cement, etc.).

In certain embodiments, the composition (e.g., invisible fingerprint material) may be coated on a substrate that is suitable for use in electronic devices. In some embodiments, for example, the composition may be coated onto an electronic component, such as a silicon wafer. According to certain embodiments, the composition may be coated onto an article for use in electronic displays, such as, but not limited to, cell phone screens, computer monitors, television screens, touch screens, appliances, and/or heads up displays.

Definitions of specific functional groups and chemical terms are described in more detail below. For purposes of this invention, the chemical elements are identified in accordance with the Periodic Table of the Elements, CAS version, Handbook of Chemistry and Physics, 75th Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

It will be appreciated that the compounds, as described herein, may be substituted with any number of substituents or functional moieties. In general, the term “substituted” whether preceded by the term “optionally” or not, and substituents contained in formulas of this invention, refer to the replacement of hydrogen radicals in a given structure with the radical of a specified substituent (e.g., a substituent which upon substitution results in a stable compound, such as a compound which does not spontaneously undergo transformation such as by rearrangement, cyclization, elimination, or other reaction). When more than one position in any given structure may be substituted with more than one substituent selected from a specified group, the substituent may be either the same or different at every position. As used herein, the term “substituted” is contemplated to include all permissible substituents of organic compounds, and includes any of the substituents described herein that results in the formation of a stable compounds. In a broad aspect, the permissible substituents include acyclic and cyclic, branched and unbranched, carbocyclic and heterocyclic, aromatic and nonaromatic substituents of organic compounds. For purposes of this invention, heteroatoms such as nitrogen may have hydrogen substituents and/or any permissible substituents of organic compounds described herein which satisfy the valencies of the heteroatoms and results in the formation of a stable moiety. Furthermore, this invention is not intended to be limited in any manner by the permissible substituents of organic compounds. Combinations of substituents and variables envisioned by this invention are preferably those that result in the formation of stable compounds useful in invisible fingerprint applications. The term “stable”, as used herein, preferably refers to compounds which possess stability sufficient to allow manufacture and which maintain the integrity of the compound for a sufficient period of time to be detected and preferably for a sufficient period of time to be useful for the purposes detailed herein.

As used herein, “alkyl” refers to a radical of a straight-chain or branched saturated hydrocarbon group having from 1 to 10 carbon atoms (“C₁-C₁₀ alkyl”). In some embodiments, an alkyl group has 1 to 9 carbon atoms (“C₁-C₉ alkyl”). In some embodiments, an alkyl group has 1 to 8 carbon atoms (“C₁-C₈ alkyl”). In some embodiments, an alkyl group has 1 to 7 carbon atoms (“C₁-C₇ alkyl”). In some embodiments, an alkyl group has 1 to 6 carbon atoms (“C₁-C₆ alkyl”). In some embodiments, an alkyl group has 1 to 5 carbon atoms (“C₁-C₅ alkyl”). In some embodiments, an alkyl group has 1 to 4 carbon atoms (“C₁-C₄ alkyl”). In some embodiments, an alkyl group has 1 to 3 carbon atoms (“C₁-C₃ alkyl”). In some embodiments, an alkyl group has 1 to 2 carbon atoms (“C₁-C₂ alkyl”). In some embodiments, an alkyl group has 1 carbon atom (“C₁ alkyl”). In some embodiments, an alkyl group has 2 to 6 carbon atoms (“C₂-C₆ alkyl”). Examples of C₁-C₆ alkyl groups include methyl (C₁), ethyl (C₂), n-propyl (C₃), isopropyl (C₃), n-butyl (C₄), tert-butyl (C₄), sec-butyl (C₄), iso-butyl (C₄), n-pentyl (C₅), 3-pentanyl (C₅), amyl (C₅), neopentyl (C₅), 3-methyl-2-butanyl (C₅), tertiary amyl (C₅), and n-hexyl (C₆). Additional examples of alkyl groups include n-heptyl (C₇), n-octyl (C₈), and the like. Unless otherwise specified, each instance of an alkyl group is independently unsubstituted (an “unsubstituted alkyl”) or substituted (a “substituted alkyl”) with one or more substituents. In certain embodiments, the alkyl group is an unsubstituted C₁-C₁₀ alkyl (e.g., —CH₃). In certain embodiments, the alkyl group is a substituted C₁-C₁₀ alkyl.

As used herein, the term “alkenyl” includes a radical of a straight-chain or branched saturated hydrocarbon group having from 2 to 10 carbon atoms, and also includes at least one carbon-carbon double bond. It will be understood that in certain embodiments, alkenyl may be advantageously of limited length, including C₂-C₁₀, C₂-C₉, C₂-C₈, C₂-C₇, C₂-C₆, C₂-C₅, C₂-C₄, and C₂-C₃.

As used herein, the term “alkynyl” includes a radical of a straight-chain or branched saturated hydrocarbon group having from 3 to 10 carbon atoms, and also includes at least one carbon-carbon triple bond. It will be understood that in certain embodiments, alkenyl may be advantageously of limited length, including C₃-C₁₀, C₃-C₉, C₃-C₈, C₃-C₇, C₃-C₆, C₃-C₅, and C₃-C₄.

It should be understood that affixing the suffix “-ene” to a group indicates the group is a divalent moiety. For example, alkylene is the divalent moiety of alkyl (e.g., an acyclic carbon or a saturated acyclic carbon chain represented by the formula —CₙH₂ₙ—), alkenylene is the divalent moiety of alkenyl (e.g., an acyclic carbon chain which contains a carbon-to-carbon double bond represented by the formula —CₙH₂ₙ₋₂—), and alkynylene is the divalent moiety of alkynyl (e.g., an acyclic carbon chain which contains a carbon-to-carbon triple bond represented by the formula —CₙH₂ₙ₋₄—). Affixing the suffice “-yne” to a group indicates the group is trivalent moiety (e.g., alkylyne is the trivalent moiety of alkyl, alkenylyne is the trivalent moiety of alkenyl, and alkynylyne is the trivalent moiety of alkynyl).

As used herein, the term “halogen” refers to fluorine (fluoro, —F), chlorine (chloro, —Cl), bromine (bromo, —Br), or iodine (iodo, —I).

As used herein, the term “hydroxy” or “hydroxyl” refers to an —OH group.

As used herein, the term “alkoxy” refers to an —O-(alkyl) or an —O-(cycloalkyl) group. Representative alkoxy group examples include, but are not limited to, methoxy, ethoxy, propoxy, butoxy, cyclopropyloxy, cyclobutyloxy, cyclopentyloxy, and the like.

As understood from the above, alkyl, alkylene, and alkylyne groups, as defined herein, are, in certain embodiments, optionally substituted. Optionally substituted refers to a group which may be substituted or unsubstituted (e.g., “substituted” or “unsubstituted” alkyl).

The following examples are intended to illustrate certain embodiments of the present invention, but do not exemplify the full scope of the invention.

### Example 1

The following example describes the synthesis and characterization of an invisible fingerprint material containing a polydimethylsiloxane additive.

An invisible fingerprint hydrolysate was synthesized by reacting 11-chloroundecyltriethoxysilane with 1,2-bis(triethoxysilyl)ethane in ethanol at room temperature for twenty hours.

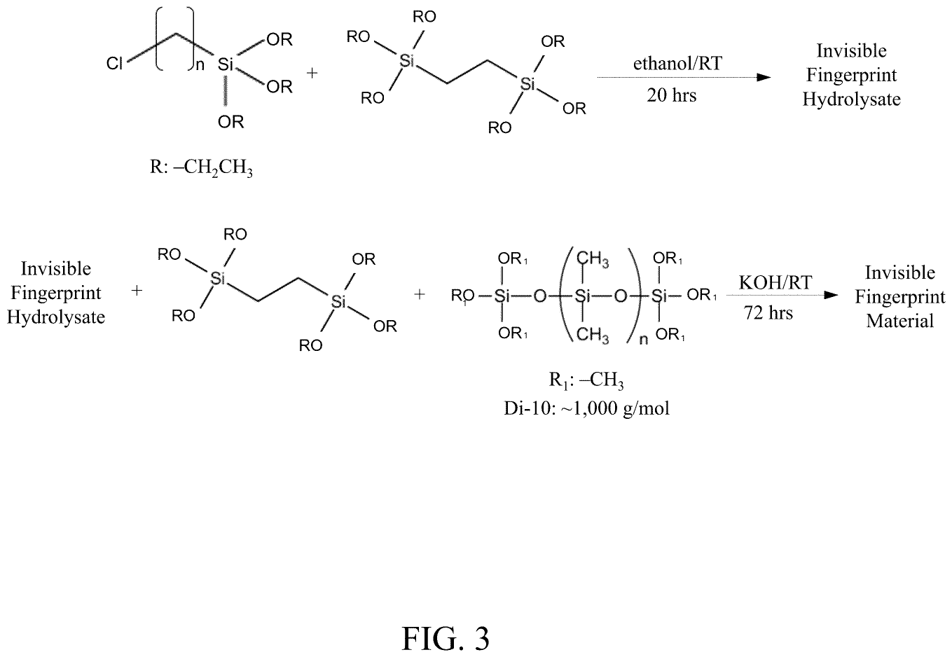

Next, 2.5 g of the invisible fingerprint hydrolysate, 0.025 g of Siltech Di-10 additive (1 wt. % versus the total weight of the invisible fingerprint hydrolysate), and 0.5 g of 1,2-bis(triethoxysilyl)ethane coupling agent (20 wt. % versus the total weight of the invisible fingerprint hydrolysate) were added to a 50 ml round-bottom flask with 24 ml of isopropyl alcohol and a catalytic amount of aqueous KOH. The reaction mixture was vigorously stirred at room temperature for 3 days. The reaction mixture was concentrated, and a clear liquid was obtained. The invisible fingerprint material reaction product was used without further purification. See FIG. 3.

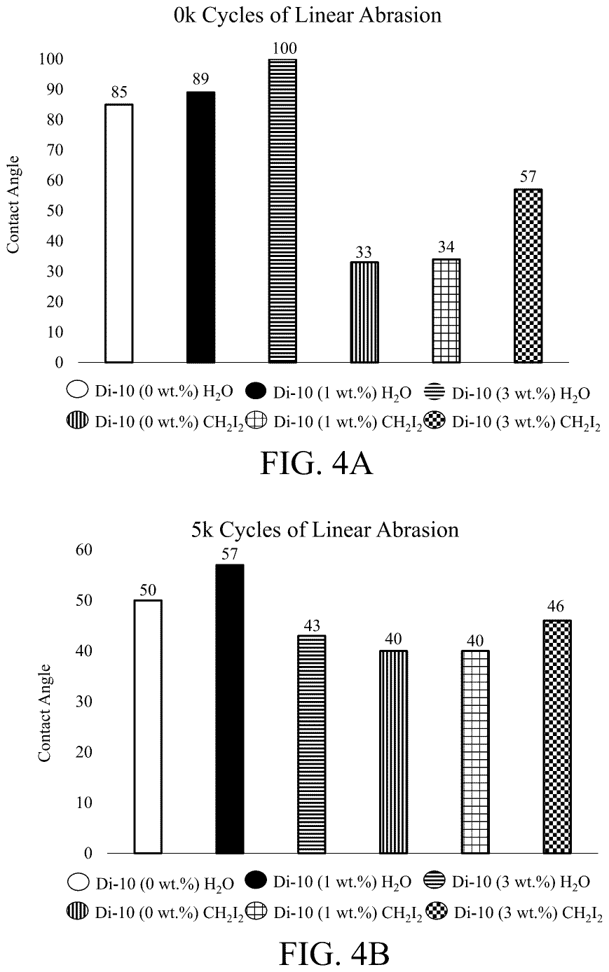

The water contact angle and the diiodomethane contact angle of the invisible fingerprint material containing the Siltech Di-10 additive in an amount of 1 wt. % versus the total weight of the invisible fingerprint material was compared to the water contact angle and the diiodomethane contact angle of: (i) an invisible fingerprint material that did not include an additive but was otherwise equivalent; and (ii) an invisible fingerprint material containing the Siltech Di-10 additive in an amount of 3 wt. % versus the total weight of the invisible fingerprint material. As shown in FIG. 4A, the water contact angle of the invisible fingerprint material that did not include an additive but was otherwise equivalent was 85°, the water contact angle of the invisible fingerprint material containing Siltech Di-10 in an amount of 1 wt. % versus the total weight of the invisible fingerprint material was 89°, and the water contact angle of the invisible fingerprint material containing Siltech Di-10 in an amount of 3 wt. % versus the total weight of the invisible fingerprint material was 100°. Also as shown in FIG. 4A, the diiodomethane contact angle of the invisible fingerprint material that did not include an additive but was otherwise equivalent was 33°, the diiodomethane contact angle of the invisible fingerprint material containing Siltech Di-10 in an amount of 1 wt. % versus the total weight of the invisible fingerprint material was 34°, and the diiodomethane contact angle of the invisible fingerprint material containing Siltech Di-10 in an amount of 3 wt. % versus the total weight of the invisible fingerprint material was 57°.

The water contact angle and the diiodomethane contact angle of the invisible fingerprint material containing the Siltech Di-10 additive in an amount of 1 wt. % versus the total weight of the invisible fingerprint material after 5,000 cycles of linear abrasion was compared to the water contact angle and the diiodomethane contact angle of: (i) an invisible fingerprint material that did not include an additive but was otherwise equivalent after 5,000 cycles of linear abrasion; and (ii) an invisible fingerprint material containing the Siltech Di-10 additive in an amount of 3 wt. % versus the total weight of the invisible fingerprint material after 5,000 cycles of linear abrasion. As shown in FIG. 4B, the water contact angle of the invisible fingerprint material that did not include an additive but was otherwise equivalent after 5,000 cycles of linear abrasion was 50° (a 41% decrease), the water contact angle of the invisible fingerprint material containing Siltech Di-10 in an amount of 1 wt. % versus the total weight of the invisible fingerprint material after 5,000 cycles of linear abrasion was 57° (a 36% decrease), and the water contact angle of the invisible fingerprint material containing Siltech Di-10 in an amount of 3 wt. % versus the total weight of the invisible fingerprint material after 5,000 cycles of linear abrasion was 43° (a 57% decrease). Also as shown in FIG. 4B, the diiodomethane contact angle of the invisible fingerprint material that did not include an additive but was otherwise equivalent after 5,000 cycles of linear abrasion was 40° (a 21% increase), the diiodomethane contact angle of the invisible fingerprint material containing Siltech Di-10 in an amount of 1 wt. % versus the total weight of the invisible fingerprint material after 5,000 cycles of linear abrasion was 40° (an 18% increase), and the diiodomethane contact angle of the invisible fingerprint material containing Siltech Di-10 in an amount of 3 wt. % versus the total weight of the invisible fingerprint material after 5,000 cycles of linear abrasion was 46° (a 19% decrease).

### Example 2

The following example describes the synthesis and characterization of another invisible fingerprint material containing a polydimethylsiloxane additive.

An invisible fingerprint hydrolysate was synthesized by reacting 11-chloroundecyltriethoxysilane with 1,2-bis(triethoxysilyl)ethane in ethanol at room temperature for twenty hours.

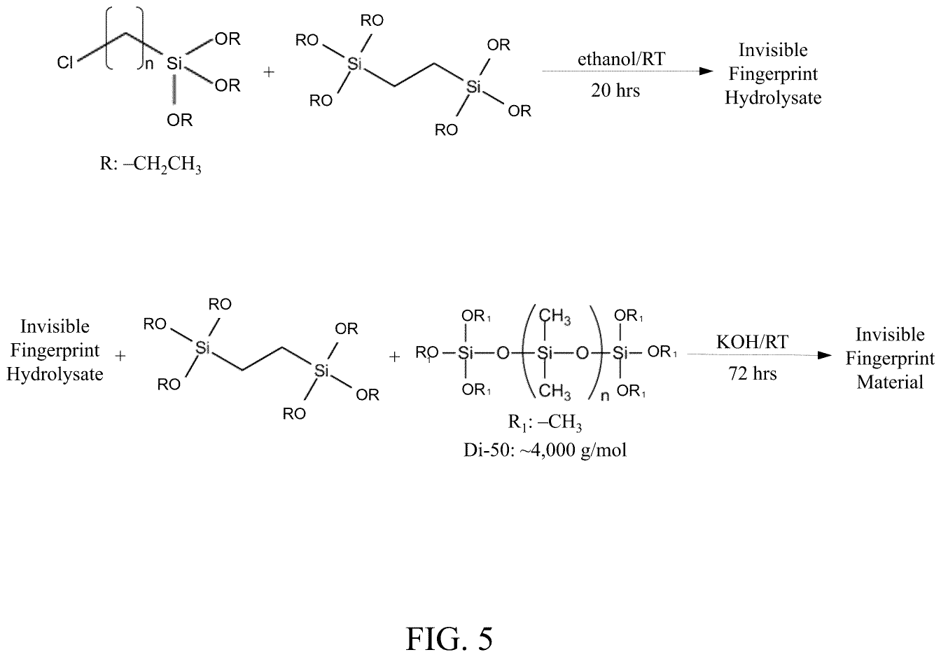

Next, 5 g of the invisible fingerprint hydrolysate, 0.05 g of Siltech Di-50 additive (1 wt. % versus the total weight of the invisible fingerprint hydrolysate), and 1 g of 1,2-bis(triethoxysilyl)ethane coupling agent (20 wt. % versus the total weight of the invisible fingerprint hydrolysate) were added to a 50 ml round-bottom flask with 24 ml of isopropyl alcohol and a catalytic amount of aqueous KOH. The reaction mixture was vigorously stirred at room temperature for 3 days. The reaction mixture was concentrated, and an opaque liquid was obtained. The invisible fingerprint material reaction product was used without further purification. See FIG. 5.

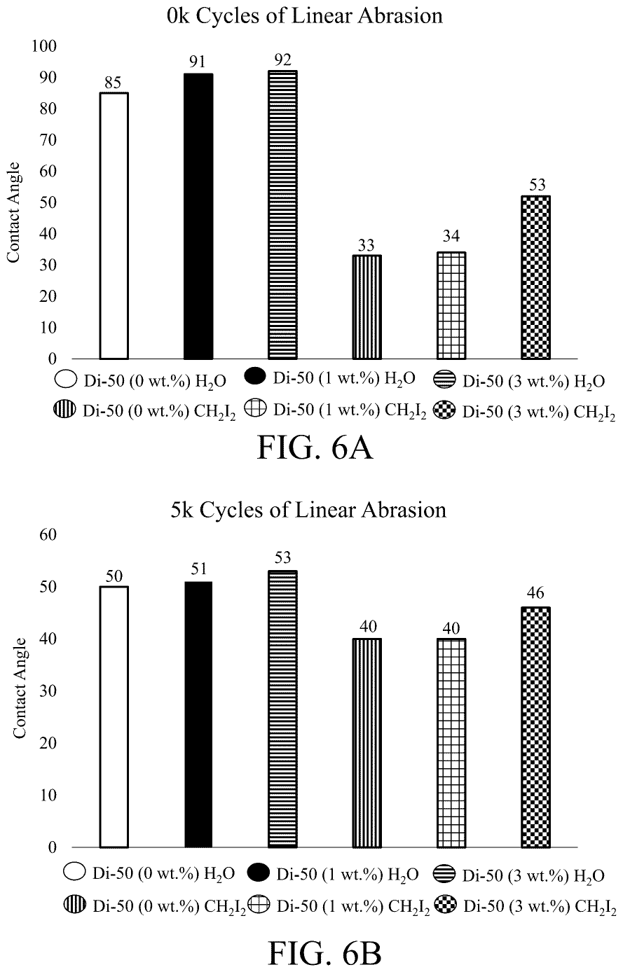

The water contact angle and the diiodomethane contact angle of the invisible fingerprint material containing the Siltech Di-50 additive in an amount of 1 wt. % versus the total weight of the invisible fingerprint material was compared to the water contact angle and the diiodomethane contact angle of: (i) an invisible fingerprint material that did not include an additive but was otherwise equivalent; and (ii) an invisible fingerprint material containing the Siltech Di-50 additive in an amount of 3 wt. % versus the total weight of the invisible fingerprint material. As shown in FIG. 6A, the water contact angle of the invisible fingerprint material that did not include an additive but was otherwise equivalent was 85°, the water contact angle of the invisible fingerprint material containing Siltech Di-50 in an amount of 1 wt. % versus the total weight of the invisible fingerprint material was 91°, and the water contact angle of the invisible fingerprint material containing Siltech Di-50 in an amount of 3 wt. % versus the total weight of the invisible fingerprint material was 92°. Also as shown in FIG. 6A, the diiodomethane contact angle of the invisible fingerprint material that did not include an additive but was otherwise equivalent was 33°, the diiodomethane contact angle of the invisible fingerprint material containing Siltech Di-50 in an amount of 1 wt. % versus the total weight of the invisible fingerprint material was 34°, and the diiodomethane contact angle of the invisible fingerprint material containing Siltech Di-50 in an amount of 3 wt. % versus the total weight of the invisible fingerprint material was 53°.

The water contact angle and the diiodomethane contact angle of the invisible fingerprint material containing the Siltech Di-50 additive in an amount of 1 wt. % versus the total weight of the invisible fingerprint material after 5,000 cycles of linear abrasion was compared to the water contact angle and the diiodomethane contact angle of: (i) an invisible fingerprint material that did not include an additive but was otherwise equivalent after 5,000 cycles of linear abrasion; and (ii) an invisible fingerprint material containing the Siltech Di-50 additive in an amount of 3 wt. % versus the total weight of the invisible fingerprint material after 5,000 cycles of linear abrasion. As shown in FIG. 6B, the water contact angle of the invisible fingerprint material that did not include an additive but was otherwise equivalent after 5,000 cycles of linear abrasion was 50° (a 41% decrease), the water contact angle of the invisible fingerprint material containing Siltech Di-50 in an amount of 1 wt. % versus the total weight of the invisible fingerprint material after 5,000 cycles of linear abrasion was 510 (a 44% decrease), and the water contact angle of the invisible fingerprint material containing Siltech Di-50 in an amount of 3 wt. % versus the total weight of the invisible fingerprint material after 5,000 cycles of linear abrasion was 530 (a 42% decrease). Also as shown in FIG. 6B, the diiodomethane contact angle of the invisible fingerprint material that did not include an additive but was otherwise equivalent after 5,000 cycles of linear abrasion was 400 (a 21% increase), the diiodomethane contact angle of the invisible fingerprint material containing Siltech Di-50 in an amount of 1 wt. % versus the total weight of the invisible fingerprint material after 5,000 cycles of linear abrasion was 40° (an 18% increase), and the diiodomethane contact angle of the invisible fingerprint material containing Siltech Di-50 in an amount of 3 wt. % versus the total weight of the invisible fingerprint material after 5,000 cycles of linear abrasion was 46° (a 13% decrease).

### Example 3

The following example describes the synthesis and characterization of an invisible fingerprint material containing polydimethylsiloxane.

In Reaction Scheme A, 2 g of Siltech Di-50 and 0.4 g of 1,1,2-tris(triethoxysilyl)ethane coupling agent (20 wt. % versus the total weight of the invisible fingerprint material) were added to a 25 ml round-bottom flask with 15 ml of isopropyl alcohol and a catalytic amount of acetic acid. The reaction mixture was vigorously stirred under reflux conditions for 4 hours. The reaction mixture was concentrated, and an opaque liquid was obtained. The invisible fingerprint material reaction product was used without further purification.

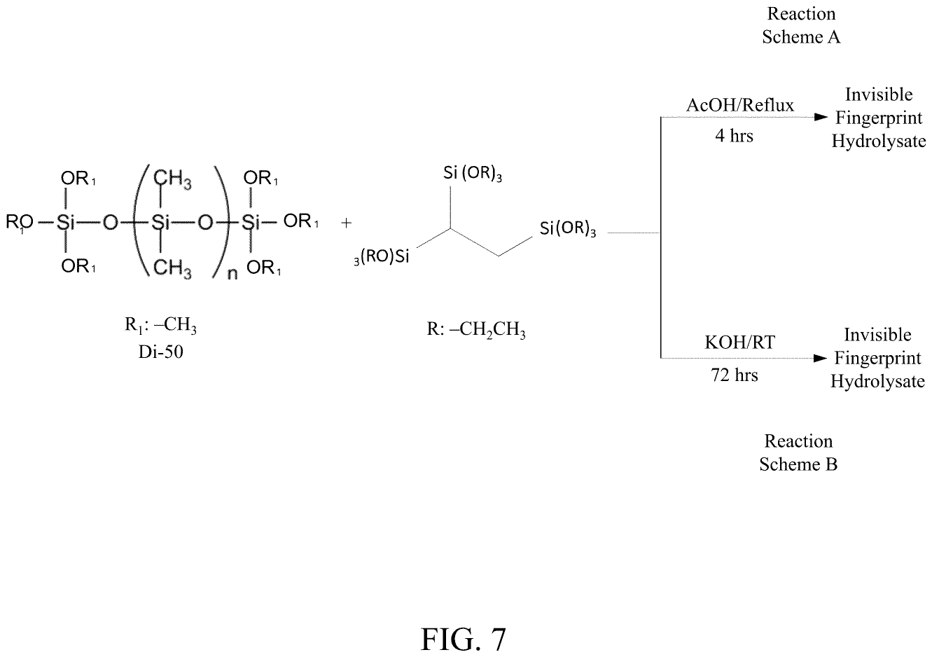

In Reaction Scheme B, 2 g of Siltech Di-50 and 0.4 g of 1,1,2-tris(triethoxysilyl)ethane coupling agent (20 wt. % versus the total weight of the invisible fingerprint material) were added to a 25 ml round-bottom flask with 15 ml of isopropyl alcohol and a catalytic amount of aqueous KOH. The reaction mixture was vigorously stirred at room temperature for 3 days. The reaction mixture was concentrated, and an opaque liquid was obtained. The invisible fingerprint material reaction product was used without further purification. See FIG. 7.

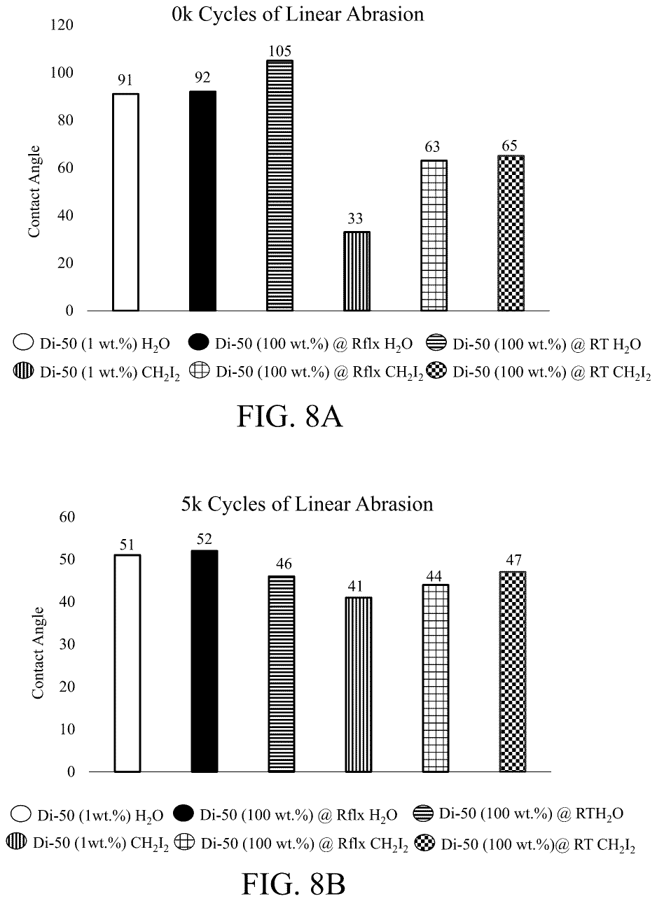

The water contact angle and the diiodomethane contact angle of the invisible fingerprint material containing the Siltech Di-50 additive in an amount of 1 wt. % versus the total weight of the invisible fingerprint material (as described above in Example 2) was compared to the water contact angle and the diiodomethane contact angle of: (i) the invisible fingerprint material of Reaction Scheme A; and (ii) the invisible fingerprint material of Reaction Scheme B. As shown in FIG. 8A, the water contact angle of the invisible fingerprint material containing the Siltech Di-50 additive in an amount of 1 wt. % versus the total weight of the invisible fingerprint material was 91°, the water contact angle of the invisible fingerprint material of Reaction Scheme A was 92°, and the water contact angle of the invisible fingerprint material of Reaction Scheme B was 105°. Also as shown in FIG. 8A, the diiodomethane contact angle of the invisible fingerprint material containing the Siltech Di-50 additive in an amount of 1 wt. % versus the total weight of the invisible fingerprint material was 33°, the diiodomethane contact angle of the invisible fingerprint material of Reaction Scheme A was 63°, and the diiodomethane contact angle of the invisible fingerprint material of Reaction Scheme B was 65°.

The water contact angle and the diiodomethane contact angle of the invisible fingerprint material containing the Siltech Di-50 additive in an amount of 1 wt. % versus the total weight of the invisible fingerprint material (as described above in Example 2) after 5,000 cycles of linear abrasion was compared to the water contact angle and the diiodomethane contact angle of: (i) the invisible fingerprint material of Reaction Scheme A after 5,000 cycles of linear abrasion; and (ii) the invisible fingerprint material of Reaction Scheme B after 5,000 cycles of linear abrasion. As shown in FIG. 8B, the water contact angle of the invisible fingerprint material containing the Siltech Di-50 additive in an amount of 1 wt. % versus the total weight of the invisible fingerprint material after 5,000 cycles of linear abrasion was 51° (a 44% decrease), the water contact angle of the invisible fingerprint material of Reaction Scheme A after 5,000 cycles of linear abrasion was 52° (a 43% decrease), and the water contact angle of the invisible fingerprint material of Reaction Scheme B after 5,000 cycles of linear abrasion was 46° (a 56% decrease). Also as shown in FIG. 8B, the diiodomethane contact angle of the invisible fingerprint material containing the Siltech Di-50 additive in an amount of 1 wt. % versus the total weight of the invisible fingerprint material after 5,000 cycles of linear abrasion was 41° (a 24% increase), the diiodomethane contact angle of the invisible fingerprint material of Reaction Scheme A after 5,000 cycles of linear abrasion was 44° (a 30% decrease), and the diiodomethane contact angle of the invisible fingerprint material of Reaction Scheme B after 5,000 cycles of linear abrasion was 47° (a 28% decrease).

### Example 4

The following example describes the coefficient of friction of an invisible fingerprint material containing a polydimethylsiloxane additive.

An invisible fingerprint material containing a polydimethylsiloxane additive in an amount of 2 wt. % versus the total weight of the invisible fingerprint material was synthesized.

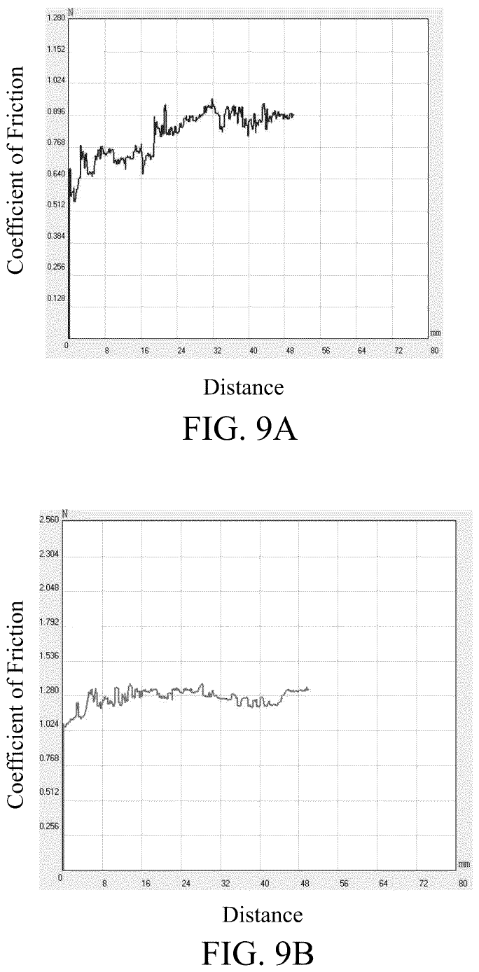

The coefficient of friction of the invisible fingerprint material containing the polydimethylsiloxane additive in an amount of 2 wt. % versus the total weight of the invisible fingerprint material was measured according to ASTM D4265-14. As shown in FIG. 9A, the coefficient of friction value was 0.085.

The coefficient of friction of an invisible fingerprint material that that did not include an additive but was otherwise equivalent was also measured according to ASTM D4265-14. As shown in FIG. 9B, the coefficient of friction value was 0.130. The incorporation of the polydimethylsiloxane additive therefore provided a 35% decrease in the coefficient of friction value.

### Example 5

The following example describes the synthesis and characterization of an invisible fingerprint material containing a polyethylene glycol additive.

An invisible fingerprint hydrolysate was synthesized by adding 7.4 of 3-[methoxy(polyethyleneoxy)]propyltrimethoxysilane to a 50 ml round-bottom flask with 20 ml of ethyl alcohol and a catalytic amount of aqueous KOH. The reaction mixture was stirred vigorously at room temperature for 20 hours. The reaction mixture was concentrated, and a clear pale-yellow liquid was obtained. The invisible fingerprint hydrolysate reaction product was used without further purification.

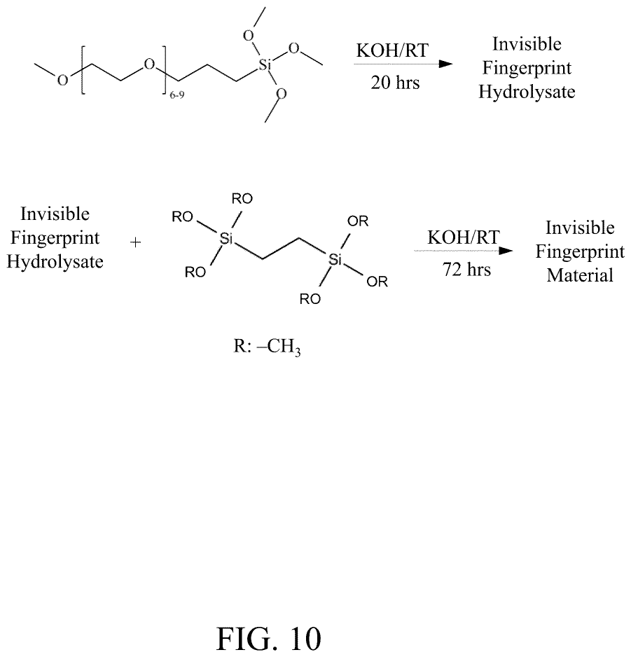

Next, 2 g of the invisible fingerprint hydrolysate and 1,2-bis(triethoxysilyl)ethane were added to a 25 ml round-bottom flask with 10 ml of isopropyl alcohol and a catalytic amount of aqueous KOH. The reaction mixture was vigorously stirred at room temperature for 3 days. The reaction mixture was concentrated, and a clear yellow liquid was obtained. The invisible fingerprint reaction product was used without further purification. See FIG. 10.

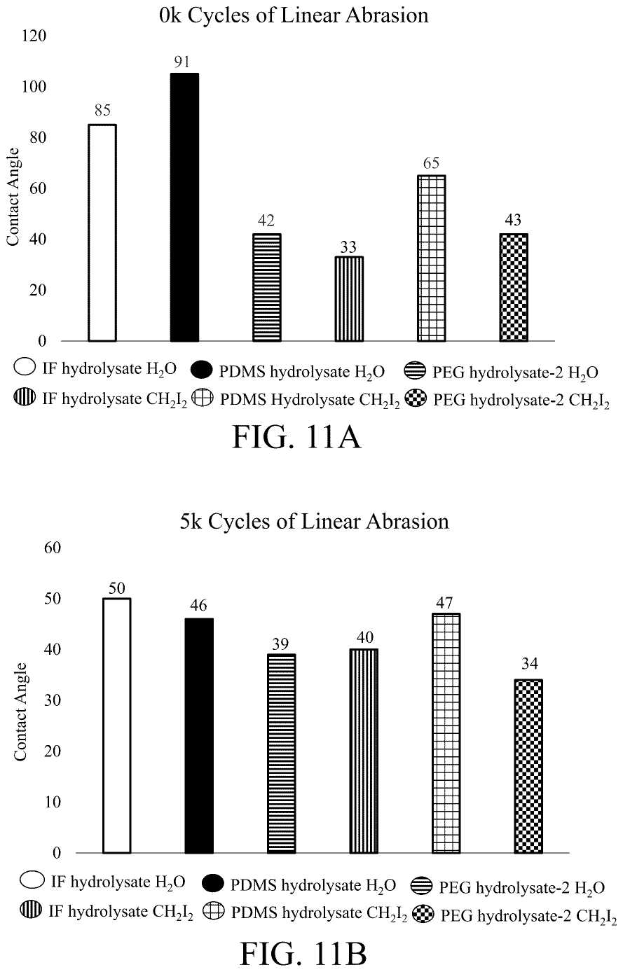

The water contact angle and the diiodomethane contact angle of the invisible fingerprint material containing the polyethylene glycol additive was compared to the water contact angle and the diiodomethane contact angle of: (i) an invisible fingerprint hydrolysate material that did not include an additive but was otherwise equivalent; and (ii) an invisible fingerprint material containing a polydimethylsiloxane additive. As shown in FIG. 11A, the water contact angle of the invisible fingerprint hydrolysate material that did not include an additive but was otherwise equivalent was 85°, the water contact angle of the invisible fingerprint material containing the polydimethylsiloxane additive was 91°, and the water contact angle of the invisible fingerprint material containing polyethylene glycol was 42°. Also as shown in FIG. 11A, the diiodomethane contact angle of the invisible fingerprint hydrolysate material that did not include an additive but was otherwise equivalent was 33°, the diiodomethane contact angle of the invisible fingerprint material containing the polydimethylsiloxane additive was 65°, and the diiodomethane contact angle of the invisible fingerprint material containing the polyethylene glycol additive was 43°.

The water contact angle and the diiodomethane contact angle of the invisible fingerprint material containing the polyethylene glycol additive after 5,000 cycles of linear abrasion was compared to the water contact angel and the diiodomethane contact angle of: (i) the invisible fingerprint material that did not include an additive but was otherwise equivalent after 5,000 cycles of linear abrasion; and (ii) the invisible fingerprint material containing a polydimethylsiloxane additive after 5,000 cycles of linear abrasion. As shown in FIG. 11B, the water contact angle of the invisible fingerprint material that did not include an additive but was otherwise equivalent after 5,000 linear abrasion cycles was 46° (a decrease of 49%), the water contact angle of the invisible fingerprint material containing the polydimethylsiloxane additive after 5,000 linear abrasion cycles was 51° (a decrease of 44%), and the water contact angle of the invisible fingerprint material containing the polyethylene glycol additive after 5,000 linear abrasion cycles was 39° (a decrease of 7%). Also as shown in FIG. 11B, the diiodomethane contact angle of the invisible fingerprint material that did not include an additive but was otherwise equivalent after 5,000 linear abrasion cycles was 40° (an increase of 21%), the diiodomethane contact angle of the invisible fingerprint material containing the polydimethylsiloxane additive after 5,000 linear abrasion cycles was 47° (a decrease of 28%), and the diiodomethane contact angle of the invisible fingerprint material containing the polyethylene glycol additive after 5,000 linear abrasion cycles was 34° (a decrease of 21%).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A composition, comprising:
an invisible fingerprint material comprising a reaction product of one or more silane-containing crosslinking agents and an additive comprising at least one hydrolysable moiety,
wherein:
the invisible fingerprint material comprises the additive in an amount greater than or equal to 0.1 weight percent (wt. %) and less than or equal to 5 wt. % versus a total weight of the invisible fingerprint material,
the invisible fingerprint material is non-fluorinated, and
the composition has a coefficient of friction of greater than or equal to 0.01 and less than or equal to 0.1.

2. The composition of claim 1, wherein the invisible fingerprint material comprises the additive in an amount greater than or equal to 0.5 wt. % and less than or equal to 1 wt. %.

3. The composition of claim 1, wherein the one or more silane-containing crosslinking agents comprise at least one hydrolysable moiety.

4. The composition of claim 1, wherein the reaction product is a reaction product of two or more silane-containing crosslinking agents and the additive comprising at least one hydrolysable moiety.

5. The composition of claim 4, wherein at least one silane-containing crosslinking agent comprises an alkyl chain.

6. The composition of claim 5, wherein the alkyl chain comprises greater than or equal to 2 and less than or equal to 20 alkyl groups.

7. The composition of claim 5, wherein the at least one silane-containing crosslinking agent comprises an oleophilic moiety.

8. The composition of claim 7, wherein the oleophilic moiety is chlorine (Cl).

9. The composition of claim 4, wherein the at least one silane-containing crosslinking agent comprises a compound of the formula: 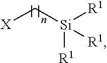
wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, and OR²,
each R² is the same or different and is selected from the group consisting of hydrogen, deuterium, —C₁-C₁₀ alkyl, —C₂-C₁₀ alkenyl, and —C₃-C₁₀ alkynyl,
X is chlorine (Cl), bromine (Br), or iodine (I), and
n is greater than or equal to 1 and less than or equal to 20.

10. The composition of claim 9, wherein X is chlorine (Cl).

11. The composition of claim 4, wherein at least one silane-containing crosslinking agent comprises a compound of the formula: 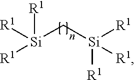
wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, and OR²,
each R² is the same or different and is selected from the group consisting of hydrogen, deuterium, —C₁-C₁₀ alkyl, —C₂-C₁₀ alkenyl, and —C₃-C₁₀ alkynyl, and
n is greater than or equal to 1 and less than or equal to 20.

12. The composition of claim 4, wherein at least one silane-containing crosslinking agent comprises a compound of the formula: 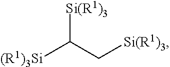
wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, and OR², and
each R² is the same or different and is selected from the group consisting of hydrogen, deuterium, —C₁-C₁₀ alkyl, —C₂-C₁₀ alkenyl, and —C₃-C₁₀ alkynyl.

13. The composition of claim 1, wherein the additive has a molecular weight greater than or equal to 1,000 Da and less than or equal to 4,000 Da.

14. The composition of claim 1, wherein the additive comprises a linear or branched compound.

15. The composition of claim 1, wherein the additive comprises a linear or branched compound of the formula: 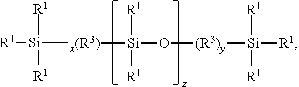
wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, OR², and —O—Si(R¹)₂—(R³)ₓ—[Si(R¹)₂—O]_{z}—(R³)_{y}—Si(R¹)₃,
each R² is the same or different and is selected from the group consisting of hydrogen, deuterium, —C₁-C₁₀ alkyl, —C₂-C₁₀ alkenyl, and —C₃-C₁₀ alkynyl,
each R³ is the same of different and is selected from the group consisting of oxygen, —C₁-C₁₀ alkylene-, —C₂-C₁₀ alkenylene-, and —C₃-C₁₀ alkynylene-,
each x is independently greater than or equal to 0,
each y is independently less than or equal to 5, and
each z is independently greater than or equal to 1.

16. The composition of claim 1, wherein the additive comprises polydimethylsiloxane.

17. The composition of claim 16, wherein the additive comprises a linear or branched compound of the formula: 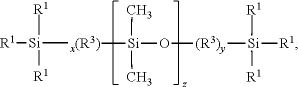
wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, OR², and —O—Si(R¹)₂—(R³)ₓ—[Si(CH₃)₂—O]_{z}—(R³)_{y}—Si(R¹)₃,
each R² is the same or different and is selected from the group consisting of hydrogen, deuterium, —C₁-C₁₀ alkyl, —C₂-C₁₀ alkenyl, and —C₃-C₁₀ alkynyl,
each R³ is the same of different and is selected from the group consisting of oxygen, —C₁-C₁₀ alkylene-, —C₂-C₁₀ alkenylene-, and —C₃-C₁₀ alkynylene-,
each x is independently greater than or equal to 0
each y is independently less than or equal to 5, and
each z is independently greater than or equal to 1.

18. The composition of claim 16, wherein the additive comprises a linear or branched compound of the formula: 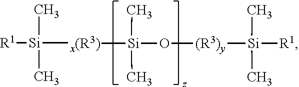
wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, OR², and —O—Si(CH₃)₂—(R³)ₓ—[Si(CH₃)₂—O]_{z}—(R³)_{y}—Si(CH₃)₂(R¹),
each R² is the same or different and is selected from the group consisting of hydrogen, deuterium, —C₁-C₁₀ alkyl, —C₂-C₁₀ alkenyl, and —C₃-C₁₀ alkynyl,
each R³ is the same of different and is selected from the group consisting of oxygen, —C₁-C₁₀ alkylene-, —C₂-C₁₀ alkenylene-, and —C₃-C₁₀ alkynylene-,
each x is independently greater than or equal to 0,
each y is independently less than or equal to 5, and
each z is independently greater than or equal to 1.

19. The composition of claim 1, wherein the additive comprises polyethylene glycol.

20. The composition of claim 19, wherein the additive comprises a linear or branched compound of the formula: 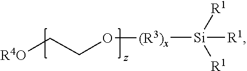
wherein:
each R¹ is the same or different and is selected from the group consisting of hydrogen, deuterium, —C₁-C₁₀ alkyl, —C₂-C₁₀ alkenyl, —C₃-C₁₀ alkynyl, a halogen, N(R²)₂, OR², and —O—[(CH₂)₂—O]_{z}—(R³)ₓ—Si(R¹)₃,
each R² is the same or different and is selected from the group consisting of hydrogen, deuterium, —C₁-C₁₀ alkyl, —C₂-C₁₀ alkenyl, and —C₃-C₁₀ alkynyl,
each R³ is selected from the group consisting of oxygen, —C₁-C₁₀ alkylene-, —C₂-C₁₀ alkenylene-, and —C₃-C₁₀ alkynylene-,
R⁴ is selected from the group consisting of hydrogen, deuterium, —C₁-C₁₀ alkyl, —C₂-C₁₀ alkenyl, and —C₃-C₁₀ alkynyl,
each x is independently greater than or equal to 0, and
each z is independently greater than or equal to 1.

21. The composition of claim 1, wherein the at least one hydrolysable moiety of the additive comprises an alkoxy moiety, a hydroxyl moiety, a hydrogen moiety, a halogen moiety, an amine, and/or combinations thereof.

22. The composition of claim 3, wherein the at least one hydrolysable moiety of the one or more silane-containing crosslinking agents comprises an alkoxy moiety, a hydroxyl moiety, a hydrogen moiety, a halogen moiety, an amine, and/or combinations thereof.

23. The composition of claim 1, wherein the reaction product is a hydrolysate.

24. The composition of claim 1, wherein a molecular weight of the reaction product is less than or equal to 100,000 Da.

25. The composition of claim 1, wherein the coefficient of friction is reduced as compared to a comparative coefficient of friction of a comparative composition that does not include the additive but is otherwise equivalent.

26. The composition of claim 25, wherein a percent reduction in the coefficient of friction as compared to the comparative coefficient of friction of the comparative composition that does not include the additive but is otherwise equivalent is greater than or equal to 20% and less than or equal to 35%.

27. The composition of claim 1, wherein a water contact angle of the composition is less than or equal to 180°.

28. The composition of claim 27, wherein the water contact angle of the composition is greater than or equal to 80°.

29. The composition of claim 27, wherein the water contact angle of the composition decreases by less than or equal to 50% after 5,000 linear abrasion cycles.

30. The composition of claim 27, wherein the water contact angle of the composition decreases by less than or equal to 10% after 5,000 linear abrasion cycles.

31. The composition of claim 29, wherein the water contact angle of the composition is greater than or equal to 70° and less than or equal to 165° after 5,000 linear abrasion cycles.

32. The composition of claim 1, wherein a diiodomethane contact angle of the composition is less than or equal to 45°.

33. The composition of claim 32, wherein the diiodomethane contact angle of the composition is greater than or equal to 1°.

34. The composition of claim 32, wherein the diiodomethane contact angle of the composition increases by less than or equal to 50% after 5,000 linear abrasion cycles.

35. The composition of claim 32, wherein the diiodomethane contact angle of the composition increases by less than or equal to 10% after 5,000 linear abrasion cycles.

36. The composition of claim 34, wherein the diiodomethane contact angle of the composition is greater than or equal to 1° and less than or equal to 45° after 5,000 linear abrasion cycles.

37-47. (canceled)
